(19) United States
(12) Patent Application Publication
(10) Pub. No.: US 2010/0126270 A1
(43) Pub. Date: May 27, 2010

(54) INERTIA FORCE SENSOR

(75) Inventors: Jirou Terada, Osaka (JP); Ichirou Satou, Osaka (JP); Takami Ishida, Osaka (JP); Takashi Imanaka, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/593,752

(22) PCT Filed: Apr. 9, 2008
(86) PCT No.: PCT/JP2008/000911

§ 371 Date: Sep. 29, 2009

(30) Foreign Application Priority Data
Apr. 13, 2007 (JP) 2007-105611
Apr. 13, 2007 (JP) 2007-105612
Sep. 6, 2007 (JP) 2007-230960
Feb. 12, 2008 (JP) 2008-030245

(51) Int. Cl. G01C 19/56

(52) U.S. Cl. 73/504.12

(57) ABSTRACT

An inertial force sensor includes a weight, a first fixing portion linked to the weight, a second fixing portion linked to the weight via the first fixing portion, a first electrode on a first surface of the weight, a second electrode facing the first electrode, and first and second elastic portions elastically deforming so as to displace the weight. The first elastic portion displaces the weight along an X-axis but not along any of a Y-axis and a Z-axis. The second elastic portion displaces the first fixing portion along the Y-axis but not along any of the X-axis and the Z-axis. This inertial force sensor detects an acceleration at high sensitivity.

### TECHNICAL FIELD

The present invention relates to an inertial force sensor used in various electronic devices for attitude control or navigation of mobile objects, such as aircrafts, automobiles, robots, marine vehicles, or vehicles.

### BACKGROUND ART

FIG. 30 is a plan view of sensor element 151 of a conventional acceleration sensor disclosed in Patent Document 1. FIGS. 31 and 32 are sectional views of sensor element 151 on line 31-31 and line 32-32, respectively.

The conventional acceleration sensor includes sensor element 151 for detecting acceleration, and a processor for processing an acceleration output from sensor element 151 to detect the acceleration. Sensor element 151 includes supporter 154 and mounters 159. Supporter 154 supports weights 152. Mounters 159 are connected to supporter 154 via flexible portions 156, and allow sensor element 151 to be mounted on a mounting board.

Flexible portions 156 have an arm shape and arranged in cross about supporter 154. Flexible portions 156 and supporter 154 are arranged in a single straight line.

Flexible portions 156 include strain-sensitive resistors 158. The resistances of strain-sensitive resistors 158 change according to the deformation of flexible portions 156 bent with the motion of weights 152. The changes are output as an acceleration signal.

Then, an operation of the conventional acceleration sensor will be described. FIG. 33 is a sectional view of sensor element 151 on line 32-32 shown in FIG. 30 receiving an acceleration.

An X-axis, a Y-axis, and a Z-axis perpendicular to each other are defined as shown in FIGS. 30, 32, and 33. Four flexible portions 156 are arranged along the X-axis and the Y-axis about supporter 154. When an acceleration, for example, along the X-axis is applied, weights 152 receive forces in the direction of the acceleration. As a result, one of two flexible portions 156 arranged along the X-axis is bent in a positive direction of the Z-axis, and the other flexible portions 156 are bent in a negative direction of the Z-axis. Thus, flexible portions 156 are bent such that weights 152 rotate about center axis 154A of supporter 154 parallel to the Y-axis. Two strain-sensitive resistors 158 on two flexible portions 156 are also bent in the positive and negative directions of the Z-axis according to the bending of flexible portions 156, thereby changing the resistances of strain-sensitive resistors 158. Strain-sensitive resistors 158 of sensor element 151 output the changes of the resistances as the acceleration signal. The processor detects the acceleration based on the signal.

This acceleration sensor is arranged such that the X-axis and the Y-axis match with directions of an acceleration to be detected so as to be installed in an attitude control device or a navigation device in mobile objects, such as vehicles.

In acceleration sensor 151, since flexible portions 156 having the arm shape are arranged in cross about supporter 154, the motion of weights 152 is restricted by flexible portions 156 arranged in the direction of the acceleration. When an acceleration occurs in the X-axis shown in FIG. 33, weights 152 is displaced along the X-axis, but the motion of weights 152 is restricted by flexible portions 156 arranged along the X-axis. This causes weights 152 to rotate about supporter 154 (center axis 154A) with respect to the Y-axis so as to bend flexible portions 156. The bending, however, is small since the force applied in a linear direction to weights 152 is converted into a force in a rotational direction. As a result, strain-sensitive resistors 158 of flexible portions 156 have small changes in resistances, and provide low detection sensitivity.

FIG. 34 is a sectional view of another conventional acceleration sensor 502 disclosed in Patent Document 2. Acceleration sensor 502 includes case 440 having a cylindrical shape, weight 441 having a circular column shape placed in case 440, and four pairs of electrodes 442 facing each other provided on weight 441 and in case 440. Case 440 has a bottom surface having recess 443 therein. Boss 444 of weight 441 is inserted in recess 443 to support weight 441.

FIG. 35 is a plan view of electrodes 442. Electrodes 442 are arranged on respective surfaces of weight 441 and case 440 facing each other.

An operation of acceleration sensor 502 will be described below. When weight 441 is displaced due to an acceleration, a gap between electrodes 442 changes, and accordingly, changes the capacitance between electrodes 442. The acceleration is detected based on the change of the capacitance. Acceleration sensor 502 is placed such that electrodes 442 face each other in a direction perpendicular to the direction of the acceleration to be detected so as to be installed in an attitude control device or a navigation device in mobile objects, such as vehicles.

In acceleration sensor 502, a capacitance is also produced between electrodes 442 adjacent to the surface of case 440 or the surface of weight 441. This capacitance generates noise which causes detection error of acceleration, and hence decreases the detection accuracy.

Patent Document 1: JP10-48243A

Patent Document 2: JP2002-55117A

### SUMMARY OF THE INVENTION

An inertial force sensor includes a weight, a first fixing portion linked to the weight, a second fixing portion linked to the weight via the first fixing portion, a first electrode on a first surface of the weight, a second electrode facing the first electrode, and first and second elastic portions elastically deforming so as to displace the weight. The first elastic portion displaces the weight along an X-axis but not along any of a Y-axis and a Z-axis. The second elastic portion displaces the first fixing portion along the Y-axis but not along any of the X-axis and the Z-axis.

This inertial force sensor detects an acceleration at high sensitivity.

### BRIEF DESCRIPTION OF THE DRAWINGS

FIG. 1 is an exploded perspective view of a sensor element of an inertial force sensor according to Exemplary Embodiment 1 of the present invention.

FIG. 2 is a sectional view of the inertial force sensor on line 2-2 shown in FIG. 1.

FIG. 3 is a sectional view of the inertial force sensor on line 3-3 shown in FIG. 1.

FIG. 4 is a perspective view of the inertial force sensor according to Embodiment 1.

FIG. 5 is a sectional view of the inertial force sensor according to Embodiment 1.

FIG. 6 is a sectional view of the inertial force sensor according to Embodiment 1.

FIG. 7 is a sectional view of the inertial force sensor according to Embodiment 1.

FIG. 8 is a sectional view of the inertial force sensor according to Embodiment 1.

FIG. 9A is an exploded perspective view of an inertial force sensor according to Exemplary Embodiment 2 of the invention.

FIG. 9B is a perspective view of a sensor element of the inertial force sensor according to Embodiment 2.

FIG. 10 is a sectional view of the inertial force sensor on line 10-10 shown in FIG. 9A.

FIG. 11 is a sectional view of the inertial force sensor on line 11-11 shown in FIG. 9A.

FIG. 12 is a sectional view of the inertial force sensor according to Embodiment 2.

FIG. 13 is a sectional view of the inertial force sensor according to Embodiment 2.

FIG. 14 is a sectional view of the inertial force sensor according to Embodiment 2.

FIG. 15 is a sectional view of the inertial force sensor according to Embodiment 2.

FIG. 16A is an exploded perspective view of an inertial force sensor according to exemplary Embodiment 3 of the invention.

FIG. 16B is a perspective view of a sensor element of the inertial force sensor according to Embodiment 3.

FIG. 17 is a sectional view of the inertial force sensor on line 17-17 shown in FIG. 16A.

FIG. 18 is a sectional view of the inertial force sensor on line 18-18 shown in FIG. 16A.

FIG. 19 is a plan view of the inertial force sensor according to Embodiment 3.

FIG. 20 is a plan view of the inertial force sensor according to Embodiment 3.

FIG. 21 is a sectional view of the inertial force sensor according to Embodiment 3.

FIG. 22 is a sectional view of the inertial force sensor according to Embodiment 3.

FIG. 23 is a sectional view of the inertial force sensor according to Embodiment 3.

FIG. 24 is a sectional view of the inertial force sensor according to Embodiment 3.

FIG. 25 is an exploded perspective view of an inertial force sensor according to Exemplary Embodiment 4 of the invention.

FIG. 26 is a sectional view of the inertial force sensor according to Embodiment 4.

FIG. 27 is a sectional view of the inertial force sensor according to Embodiment 4.

FIG. 28 is a plan view of the inertial force sensor according to Embodiment 4.

FIG. 29 is a plan view of the inertial force sensor according to Embodiment 4.

FIG. 30 is a plan view of a conventional acceleration sensor.

FIG. 31 is a sectional view of the acceleration sensor on lines 31-31 shown in FIG. 30.

FIG. 32 is a sectional view of the acceleration sensor pm line 32-32 shown in FIG. 30.

FIG. 33 is a sectional view of the acceleration sensor shown in FIG. 30.

FIG. 34 is a plan view of another conventional acceleration sensor.

FIG. 35 is a plan view of electrodes of the acceleration sensor shown in FIG. 34.

### REFERENCE NUMERALS

103A Weight (First Weight)
103B Weight (Second Weight)
103C Weight (Third Weight)
103D Weight
104 Fixing Portion (First Fixing Portion)
105 Substrate (First Substrate)
106 Fixing Portion (Second Fixing Portion)
109 Elastic Portion (First Elastic Portion)
110A Arm
110B Arm
110C Arm
110D Arm
111 Elastic Portion (Second Elastic Portion)
113A Slit
113B Slit
114 Opposed Electrode Unit (First Opposed Electrode Unit)
114A Electrode (First Electrode)
114B Electrode (Second Electrode)
116 Opposed Electrode Unit (Second Opposed Electrode Unit)
116A Electrode (Third Electrode)
116B Electrode (Fourth Electrode)
118 Opposed Electrode Unit (Second Opposed Electrode Unit)
118A Electrode (Third Electrode)
118B Electrode (Fourth Electrode)
203A Weight (First Weight)
203B Weight (Second Weight)
204 Fixing Portion (First Fixing Portion)
205 Substrate (First Substrate)
206 Fixing Portion (Second Fixing Portion)
209 Elastic Portion (First Elastic Portion)
210A Arm
210B Arm
210C Arm
210D Arm
211 Elastic Portion (Second Elastic Portion)
214 Opposed Electrode Unit (First Opposed Electrode Unit)
214A Electrode (First Electrode)
214B Electrode (Second Electrode)
215 Substrate (Second Substrate)
216 Opposed Electrode Unit (Second Opposed Electrode Unit)
216A Electrode (Third Electrode)
216B Electrode (Fourth Electrode)
217 Opposed Electrode Unit (Second Opposed Electrode Unit)
217A Electrode (Third Electrode)
217B Electrode (Fourth Electrode)
218 Opposed Electrode Unit (Third Opposed Electrode Unit, Fifth Opposed Electrode Unit)
218A Electrode (Fifth Electrode, Ninth Electrode)
218B Electrode (Sixth Electrode, Tenth Electrode)
219 Opposed Electrode Unit (Fourth Opposed Electrode Unit)
219A Electrode (Seventh Electrode)
219B Electrode (Eighth Electrode)
221 Opposed Electrode Unit (Sixth Opposed Electrode Unit)
221A Electrode (Eleventh Electrode)
221B Electrode (Twelfth Electrode)
213A Slit
213B Slit
303A Weight (First Weight)
303B Weight (Second Weight)
303C Weight (Third Weight)
303D Weight
304 Fixing Portion (First Fixing Portion)
306 Fixing Portion (Second Fixing Portion)
305 Substrate (First Substrate)
310A Arm
310B Arm
310C Arm
310D Arm
314A Electrode (First Electrode)
314B Electrode (Second Electrode)
314C Electrode (Second Electrode)
314X Opposed Electrode Unit (First Opposed Electrode Unit)
314Y Opposed Electrode Unit (First Opposed Electrode Unit)
315 Substrate (Second Substrate)
316A Electrode (Third Electrode)
316B Electrode (Fourth Electrode)
316C Electrode
316X Opposed Electrode Unit (Second Opposed Electrode Unit)
316Y Opposed Electrode Unit
317A Electrode (Third Electrode)
317B Electrode (Fourth Electrode)
317C Electrode
317X Opposed Electrode Unit (Second Opposed Electrode Unit)
317Y Opposed Electrode Unit
318A Electrode (Fifth Electrode)
318B Electrode
318C Electrode (Sixth Electrode)
318X Opposed Electrode Unit
318Y Opposed Electrode Unit (Third Opposed Electrode Unit)
319A Electrode (Seventh Electrode)
319B Electrode (Eighth Electrode)
319C Electrode
319X Opposed Electrode Unit (Fourth Opposed Electrode Unit)
319Y Opposed Electrode Unit
321A Electrode (Eleventh Electrode)
321B Electrode
321C Electrode (Twelfth Electrode)
321X Opposed Electrode Unit
321Y Opposed Electrode Unit (Sixth Opposed Electrode Unit)
309 Elastic Portion (First Elastic Portion)
311 Elastic Portion (Second Elastic Portion)
313A Slit
313B Slit
430 Grounding Electrode (First Grounding Electrode)
440 Grounding Electrode (Second Grounding Electrode)
1001 Inertial Force Sensor
1001A Object
1002 Inertial Force Sensor
1002A Object
1003 Inertial Force Sensor
1003A Object
1004 Inertial Force Sensor
X X-Axis (Second Axis)
Y Y-Axis (Third Axis)
Z Z-Axis (First Axis)

### DETAILED DESCRIPTION OF PREFERRED EMBODIMENTS

### Exemplary Embodiment 1

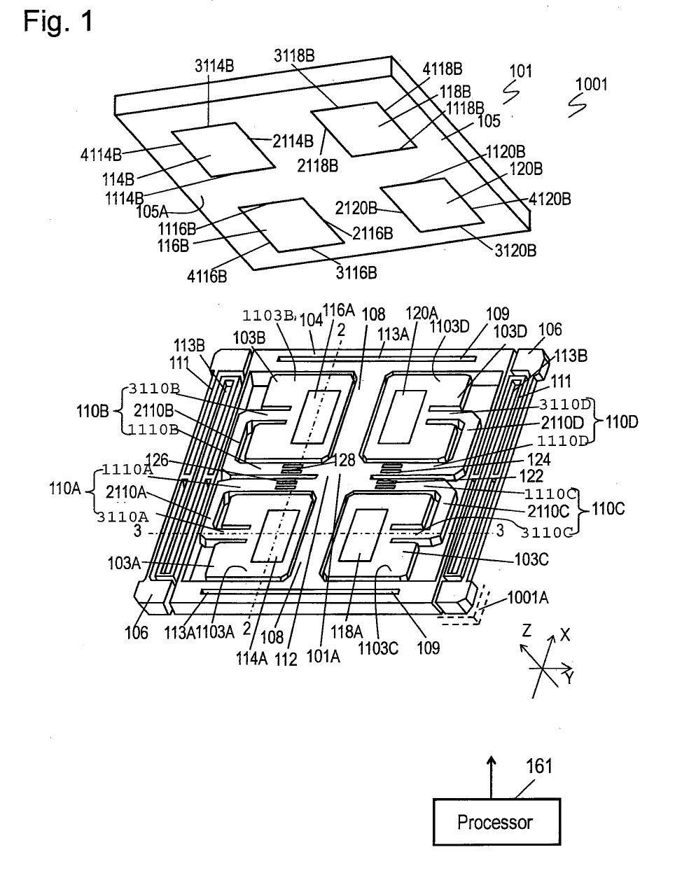

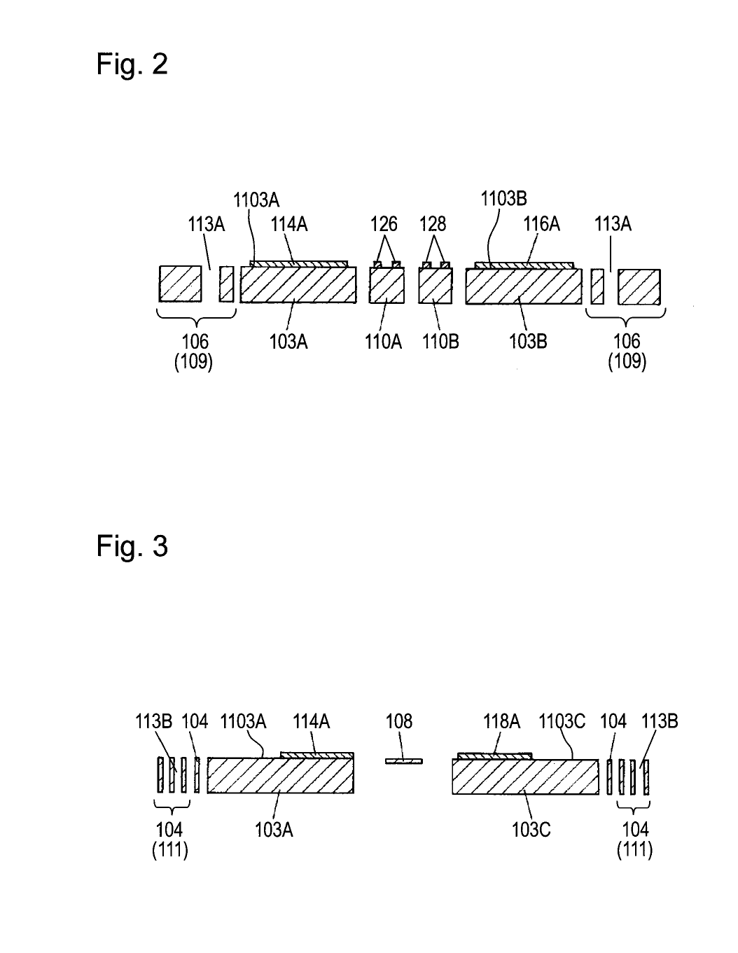

FIG. 1 is an exploded perspective view of sensor element 101 of inertial force sensor 1001 according to Exemplary Embodiment 1 of the present invention. FIGS. 2 and 3 are sectional views of sensor element 101 on line 2-2 and line 3-3 shown in FIG. 1, respectively. Inertial force sensor 1001 can detect an acceleration and an angular velocity.

A Z-axis, an X-axis, and a Y-axis, a first axis, a second axis, and a third axis, perpendicular to each other are defined as shown in FIG. 1. Two arms 108 extend from supporter 112 along the X-axis and are connected to fixing portion 104 having a frame shape. Supporter 112 is joined to fixing portion 104 via arms 108. Arms 108 extend perpendicularly to fixing portion 104. Four arms 110A to 110D extend from supporter 112 along the Y-axis and are connected to four weights 103A to 103D, respectively. Arms 108 and 110A to 110D are flexible and constitute a flexible portion together with supporter 112. The flexible portion is connected to fixing portion 104. Weights 103A to 103D are linked to fixing portion 104 via the flexible portion. Arms 108 are much thinner and hence more flexible than arms 110A to 110D. Weights 103A to 103D have surfaces 1103A to 1103D facing substrate 105.

Electrodes 114A, 116A, 118A, and 120A are provided on surfaces 1103A, 1103B, 1103C, and 1103D of weights 103A, 103B, 103C and 103D, respectively. Substrate 105 is attached to fixing portion 104. Substrate 105 has surface 105A facing weights 103A to 103D along the Z-axis. Electrodes 114B, 116B, 118B, and 120B provided on surface 105A of substrate 105 face electrodes 114A, 116A, 118A, and 120A along the Z-axis, respectively, and are spaced from electrodes 114A, 116A, 118A, and 120A, respectively. Electrodes 114A and 114B providing a capacitance between the electrodes constitute opposed electrode unit 114. Electrodes 116A and 116B providing a capacitance between the electrodes constitute opposed electrode unit 116. Electrodes 118A and 118B providing a capacitance between the electrodes constitute opposed electrode unit 118. Electrodes 120A and 120B providing a capacitance between the electrodes constitute opposed electrode unit 120. Electrodes 114A and 116A are arranged along the X-axis. Electrodes 114B and 116B are arranged along the X-axis. Thus, opposed electrode units 114 and 116 are arranged along the X-axis. Electrodes 118A and 120A are arranged along the X-axis. Electrodes 118B and 120B are arranged along the X-axis. Thus, opposed electrode units 118 and 120 are arranged along the X-axis. Electrodes 114A and 118A are arranged along the Y-axis. Electrodes 114B and 118B are arranged along the Y-axis. Thus, opposed electrode units 114 and 118 are arranged along the Y-axis. Electrodes 116A and 120A are arranged along the Y-axis. Electrodes 116B and 120B are arranged along the Y-axis. Thus, opposed electrode units 116 and 120 are arranged along the Y-axis.

Arm 110A extending from supporter 112 includes extension 1110A extending from supporter 112 along the Y-axis, extension 3110A extending in parallel with extension 1110A along the Y-axis, and connecting portion 2110A connecting between extensions 1110A and 3110A, thus having substantially a U-shape. Connecting portion 2110A extends from extension 1110A along the X-axis. Extension 3110A is connected to weight 103A. Arm 110B extending from supporter 112 includes extension 1110B extending from supporter 112 along the Y-axis, extension 3110B extending in parallel with extension 1110B along the Y-axis, and connecting portion 2110B connecting between extensions 1110B and 3110B, thus having substantially a U-shape. Connecting portion 2110B extends from extension 1110B along the X-axis in a direction opposite to the direction in which connecting portion 2110A of arm 110A extends. Extension 3110B is connected to weight 103B. Arm 110C extending from supporter 112 includes extension 1110C extending from supporter 112 along the Y-axis, extension 3110C extending in parallel with extension 1110C along the Y-axis, and connecting portion 2110C connecting between extensions 1110C and 3110C, thus having substantially a U-shape. Connecting portion 2110C extends from extension 1110C along the X-axis in a direction identical to the direction in which connecting portion 2110A of arm 110A extends. Extension 3110C is connected to weight 103C. Arm 110D extending from supporter 112 includes extension 1110D extending from supporter 112 along the Y-axis, extension 3110D extending in parallel with extension 1110D along the Y-axis, and connecting portion 2110D connecting between extensions 1110D and 3110D, thus having substantially a U-shape. Connecting portion 2110D extends from extension 1110D along the X-axis in a direction opposite to the direction in which connecting portion 2110C of arm 110C extends. Extension 3110D is connected to weight 103D. Extensions 1110A to 1110D and 3110A to 3110D of arms 110A to 110D extend perpendicularly to fixing portions 104 and 106.

Arms 108 and supporter 112 are arranged substantially on a single straight line. Extensions 1110A and 1110B of arms 110A and 110B extend in the same direction from supporter 112. Extensions 1110C and 1110D of arms 110C and 110D extend in the same direction from supporter 112 and in the direction opposite to the direction in which extensions 1110A and 1110B of arms 110A and 110B extends.

Weights 103A to 103D are arranged inside the frame shape of fixing portion 104. Fixing portion 104 is linked to fixing portion 106 via fixing arm 107, and placed inside fixing portion 106. Arms 108 and supporter 12 are arranged substantially on the single straight line. Arms 18 are arranged symmetrically to each other with respect to center 101A of sensor element 101. Arms 110A to 110D are arranged symmetrically to each other with respect to center 101A of sensor element 101. Arms 108 and 110A to 110D function as a linking unit for linking weights 103A to 103D to fixing portion 104. Fixing arm 107 functions as a linking unit for linking fixing portion 104 to fixing portion 106.

Fixing portion 104 includes elastic portions 109 which elastically deform only along the X-axis, that is, which do not substantially deform along any of the Y-axis and the Z-axis. Fixing arm 107 extends along the Y-axis. Fixing portion 106 includes elastic portions 111 which elastically deform only along the Y-axis, that is, which do not substantially deform along any of the X-axis and the Z-axis. Fixing portion 106 is arranged to be mounted to mounting substrate 1001A, an object.

Elastic portions 109 are implemented by slits 113A which is provided in fixing portion 104 and which extend along the Y-axis. Elastic portions 111 are implemented by slits 113B which is provided in fixing portion 106 and which extend along the X-axis.

Driving electrode 122 which drives and vibrates weight 103C is provided on arm 110C. Detecting electrode 124 which detects the vibration of arm 110D is provided on arm 110D. Sensing electrodes 126 and 128, which sense strain on arms 110A and 110B are provided on arms 110A and 110B, respectively. Driving electrode 122 includes a lower electrode on arm 110C, a piezoelectric layer on the lower electrode, and an upper electrode on the piezoelectric layer. Similarly, electrode 124 (126, 128) includes a lower electrode on arm 110D (110A, 110B), a piezoelectric layer on the lower electrode, and an upper electrode on the piezoelectric layer.

Opposed electrode units 114, 116, 118, and 120, driving electrode 122, detecting electrode 124, and sensing electrodes 126 and 128 are connected to fixing portion 106 via signal lines and electrically connected to circuit patterns on mounting substrate 1001A via, e.g. bonding wires at ends of the signal lines. Opposed electrode units 114, 116, 118, and 120, driving electrode 122, detecting electrode 124, and sensing electrodes 126 and 128 are connected to processor 161 via the signal lines and mounting substrate 1001A.

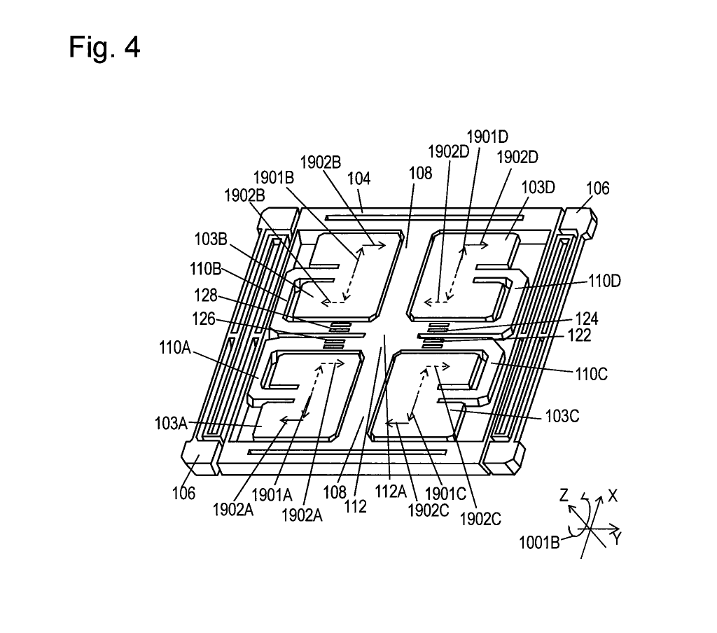

An operation of sensor element 101 of inertial force sensor 1001 to detect an angular velocity will be described below. FIG. 4 is a perspective view of sensor element 101. Arm 110C extending from supporter 112 together with weight 103C connected to arm 110C has a natural resonance frequency. When an alternating-current (AC) voltage having the resonance frequency is applied between the upper and lower electrodes of driving electrode 122 from a driving power source, arm 110C causes weight 103C to vibrate in direction 1901C along the X-axis at the resonance frequency. Arms 110A, 110B, and 110D extending from supporter 112, and weights 103A, 103B, and 103D connected to arms 110A, 110B, and 110D have the same natural resonance frequency as arm 110C and weight 103C. Since supporter 112 is linked to fixing portion 104 via flexible arm 8, when arm 110C and weight 103C vibrate at the resonance frequency, the vibration propagates to arms 110A, 110B, and 110D via supporter 112 to vibrate weights 103A, 103B, and 103D at the resonance frequency in directions 1901A, 1901B, and 1901D, respectively, along the X-axis. Detecting electrode 124 feeds back a voltage which changes according to the vibration of arm 110D to the driving power source. The driving power source determines the amplitude, the frequency, and the phase of the AC voltage applied to driving electrode 122 based on the voltage fed back so that arm 110D can vibrate by a constant amplitude, thereby vibrating arms 110A to 110D by the constant amplitude at the resonance frequency.

An operation of sensor element 1 will be described below in which angular velocity 1001B counterclockwise with respect to the Z-axis, that is, in the direction causing weight 103A to approach weight 103C, is applied while weights 103A to 103D vibrate in directions 1901A to 1901D, respectively, along the X-axis. When weights 103A to 103D vibrate, Coriolis force is generated in directions 1902A to 1902D which are along the Y-axis and perpendicular to directions 1901A to 1901D, respectively, thereby producing arms 110A to 110D to have strains. Sensing electrodes 126 and 128 output voltages according to the strains produced in arms 110A and 110B. Processor 161 detects angular velocity 1001B based on the voltages.

An operation of inertial force sensor 1001 to detect an acceleration will be described below.

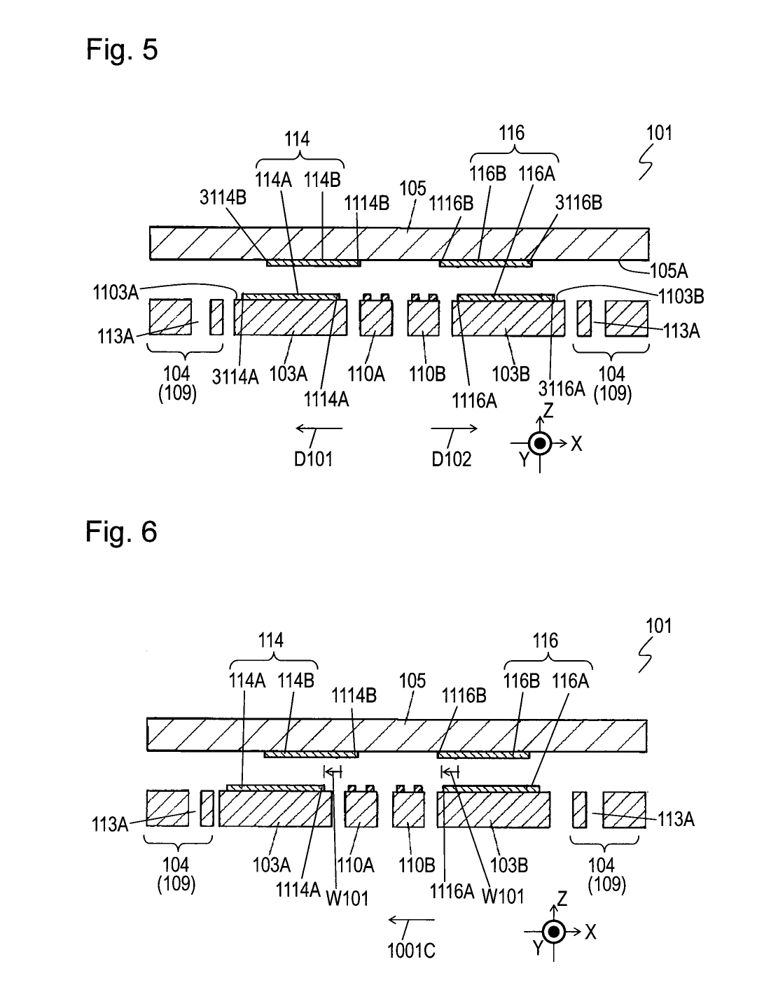

First, an operation of inertial force sensor 1001 to detect an acceleration along the X-axis will be described below. FIG. 5 is a sectional view of sensor element 101 on line 2-2 shown in FIG. 1 when no acceleration is applied along the X-axis. Electrodes 114A and 114B have ends 1114A and 1114B directed in the same direction along the X-axis. Electrodes 116A and 116B have ends 1116A and 1116B directed in the same direction along the X-axis. Ends 1114A and 1114B face ends 1116A and 1116B, respectively. When no acceleration is applied, end 1114A of electrode 114A deviates slightly from end 1114B of electrode 114B in direction D101 along the X-axis, and end 1116A of electrode 116A deviates slightly from end 1116B of electrode 116B in direction D102 opposite to direction D101. Similarly, when no acceleration is applied, ends of electrodes 118A and 118B directed in the same direction deviate slightly from each other along the X-axis. Ends of electrodes 120A and 120B directed in the same direction deviate slightly from each other in a direction opposite to the direction in which the ends of electrodes 118A and 118B deviates along the X-axis. Electrodes 114A and 114B have ends 3114A and 3114B side opposite to ends 1114A and 1114B, respectively, along the X-axis. When no acceleration is applied, end 3114A of electrode 114A deviates slightly from end 3114B of electrode 114B in direction D101 along the X-axis. Electrodes 116A and 116B have ends 3116A and 3116B opposite to ends 3116A and 3116B, respectively, along the X-axis. When no acceleration is applied, end 3116A of electrode 116A deviates slightly from end 3116B of electrode 116B in direction D102.

FIG. 6 is a sectional view of sensor element 101 on line 2-2 shown in FIG. 1 when an acceleration along the X-axis. When acceleration 1001C in direction D101 along the X-axis is applied, a force along the X-axis due to acceleration 1001C deforms elastic portions 109 along the X-axis but not along any of the Y-axis and the Z-axis while the force is not converted into a rotational force. As a result, ends 1114A and 1116A of electrodes 114A and 116A are displaced relatively with respect to ends 1114B and 1116B of electrodes 114B and 116B by large distance W101 along the X-axis. Similarly, the ends of electrodes 118A and 120A are displaced relatively with respect to the ends of electrodes 118B and 120B by large distance W101 along the X-axis. Acceleration 1001C displaces weights 103A and 103B along the X-axis, and changes the capacitances of opposed electrode units 114 and 116 by amounts different from each other. Similarly, the acceleration displaces weights 103C and 103D along the X-axis, and changes the capacitances of opposed electrode units 118 and 120 by amounts different from each other.

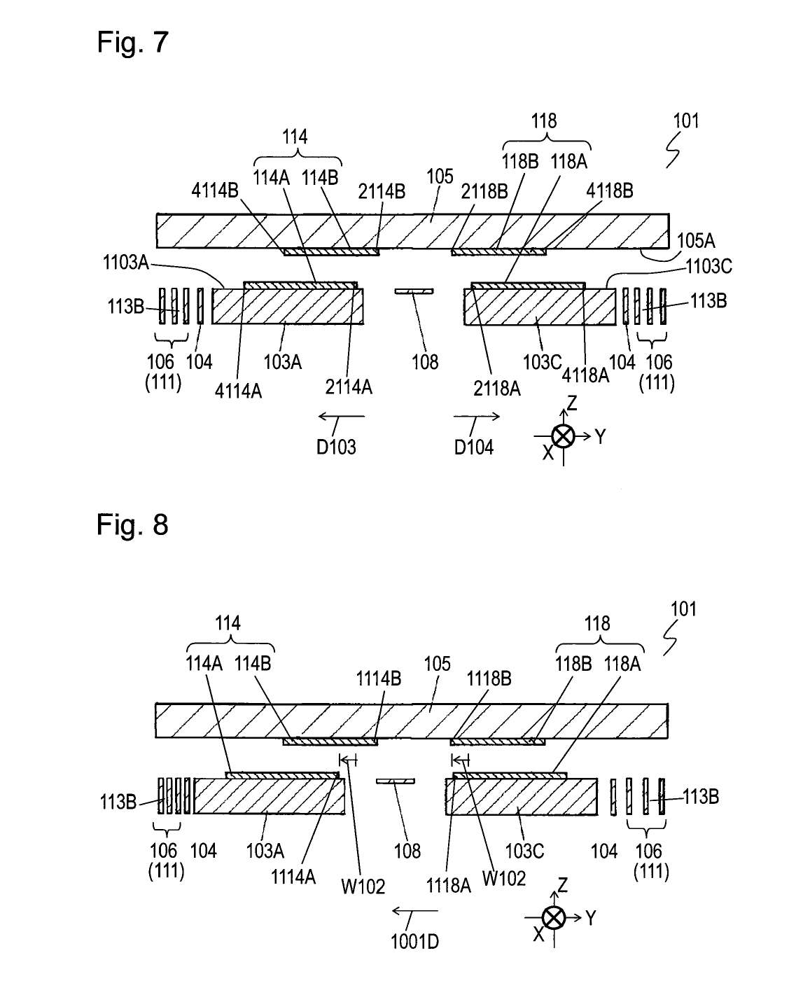

Next, an operation of inertial force sensor 1001 to detect an acceleration along the Y-axis will be described below. FIG. 7 is a sectional view of sensor element 101 on line 3-3 shown in FIG. 1 when no acceleration is applied along the Y-axis. Electrodes 114A and 114B have ends 2114A and 2114B directed in the same direction along the Y-axis. Electrodes 118A and 118B have ends 2118A and 2118B directed in the same direction along the Y-axis. Ends 2114A and 2114B face ends 2118A and 2118B, respectively. When no acceleration is applied, end 2114A of electrode 114A deviates slightly from end 2114B of electrode 114B in direction D103 along the Y-axis. End 2118A of electrode 118A deviates slightly from end 2118B of electrode 118B along the Y-axis in direction D104 opposite to direction D103. Similarly, when no acceleration is applied, ends of electrodes 116A and 116B directed in the same direction deviate slightly from each other along the Y-axis. Ends of electrodes 120A and 120B directed in the same direction deviate slightly from each other in a direction opposite to the direction in which the ends of electrodes 116A and 116B deviate along the Y-axis. Electrodes 114A and 114B have ends 4114A and 4114B opposite to ends 2114A and 2114B, respectively, along the Y-axis. When no acceleration is applied, end 4114A of electrode 114A deviates slightly from end 4114B of electrode 114B in direction D103 along the Y-axis. Electrodes 118A and 118B have ends 4118A and 4118B opposite to ends 2118A and 2118B, respectively, along the Y-axis. When no acceleration is applied, end 4118A of electrode 118A deviate slightly from end 4118B of electrode 118B in direction D104.

FIG. 8 is a sectional view of sensor element 101 on line 3-3 shown in FIG. 1 when an acceleration along the Y-axis is applied. When acceleration 1001D in direction D103 along the Y-axis is applied, a force along the Y-axis due to acceleration 1001D deforms elastic portions 111 along the Y-axis but not along any of the Y-axis and the Z-axis while the force is not converted into a rotational force. The force displaces ends 2114A and 2118A of electrodes 114A and 118A relatively with respect to ends 2114B and 2118B of electrodes 114B and 118B by large distance W102 along the Y-axis. Similarly, the force displaces the ends of electrodes 114A and 120A relatively with respect to the ends of electrodes 114B and 120B by large distance W102 along the Y-axis. Acceleration 1001D displaces weights 103A and 103C along the Y-axis, and changes the capacitance of opposed electrode units 114 and 118 by amounts different from each other. Similarly, acceleration 1001D displaces weights 103B and 103D along the Y-axis, and the capacitances of opposed electrode units 116 and 120 by amounts different from each other.

Thus, the capacitances of opposed electrode units 114, 116, 118, and 120 change according to accelerations 1001C and 1001D along the X-axis and the Y-axis. Processor 161 can detect accelerations 1001C and 1001D based on the changes of the capacitances.

Sensor element 101 can detect acceleration 1001C along the X-axis since elastic portions 109 deform along the X-axis but not along any of the Y-axis and the Z-axis. Sensor element 101 can detect acceleration 1001D along the Y-axis since elastic portions 111 deform along the Y-axis but not along any of the X-axis and the Z-axis. Thus, sensor element 101 can detect acceleration 1001C along the X-axis and acceleration 1001D along the Y-axis at high sensitivity independently without mutual interference.

The amount of the change of the capacitance of opposed electrode unit 114 due to acceleration 1001C is different from the amount of the change of the capacitance of opposed electrode unit 116 due to acceleration 1001C. Similarly, the amount of the change of the capacitance of opposed electrode unit 118 due to acceleration 1001C is different from the amount of the change of the capacitance of opposed electrode unit 120 due to acceleration 1001C. For example, when acceleration 1001C directed in the negative direction of the X-axis is applied, as shown in FIG. 6, opposed electrode units 114 and 118 decrease their capacitances, and opposed electrode units 116 and 120 increase their capacitance. When an acceleration in the positive direction of the X-axis is applied, weights 103A to 103D are displaced in the direction opposite to the direction shown in FIG. 6. Therefore, opposed electrode units 114 and 118 increase their capacitances, and opposed electrode units 116 and 120 decrease their capacitances. As a result, processor 161 connected to sensor element 101 can determine, based on the capacitances of opposed electrode units 114, 116, 118, and 120, whether weights 103A to 103D are displaced in the positive direction or in the negative direction of the X-axis based on the capacitances of opposed electrode units 114, 116, 118, and 120. Similarly, when acceleration 1001D directed in the negative direction of the Y-axis is applied, as shown in FIG. 8, opposed electrode units 114 and 116 decrease their capacitances, and opposed electrode units 118 and 120 increase their capacitances. When an acceleration directed in the positive direction of the Y-axis is applied, weights 103A to 103D are displaced in the direction opposite to the direction shown in FIG. 8. Therefore, opposed electrode units 114 and 116 increase their capacitances, and opposed electrode units 118 and 120 decrease their capacitances. As a result, processor 161 can determine, based on the capacitances of opposed electrode units 114, 116, 118, and 120, whether weights 103A to 103D have been displaced in the positive direction or the negative direction of the Y-axis.

Single sensor element 101 can detect both the acceleration and the angular velocity, and allows inertial force sensor 1001 to have a small footprint and a small size.

Elastic portions 109 which deform along the X-axis but not along any of the Y-axis and the Z-axis are provided at fixing portion 104 of sensor element 101 of inertial force sensor 1001. Alternatively, elastic portions 109 may be provided at arms 108 functioning as the linking unit of the inertial force sensor according to Embodiment 1. Elastic portions 111 which deform along the Y-axis but not along any of the X-axis and the Z-axis are provided at fixing portion 106 of sensor element 101. Alternatively, elastic portions 111 may be provided at fixing arm 107 functioning as the linking unit of the inertial force sensor according to Embodiment 1.

Driving electrode 122, detecting electrode 124, and sensing electrodes 126 and 128 for detecting the angular velocity may have shapes and positions other than those described above.

Electrodes 114A, 116A, 118A, and 120A are largely displaced in the direction of the acceleration with respect to electrodes 114B, 116B, 118B, and 120B without causing the force due to the acceleration to be converted into a rotational force. Inertial force sensor 1001 according to Embodiment 1 detects the acceleration at high sensitivity accordingly.

### Exemplary Embodiment 2

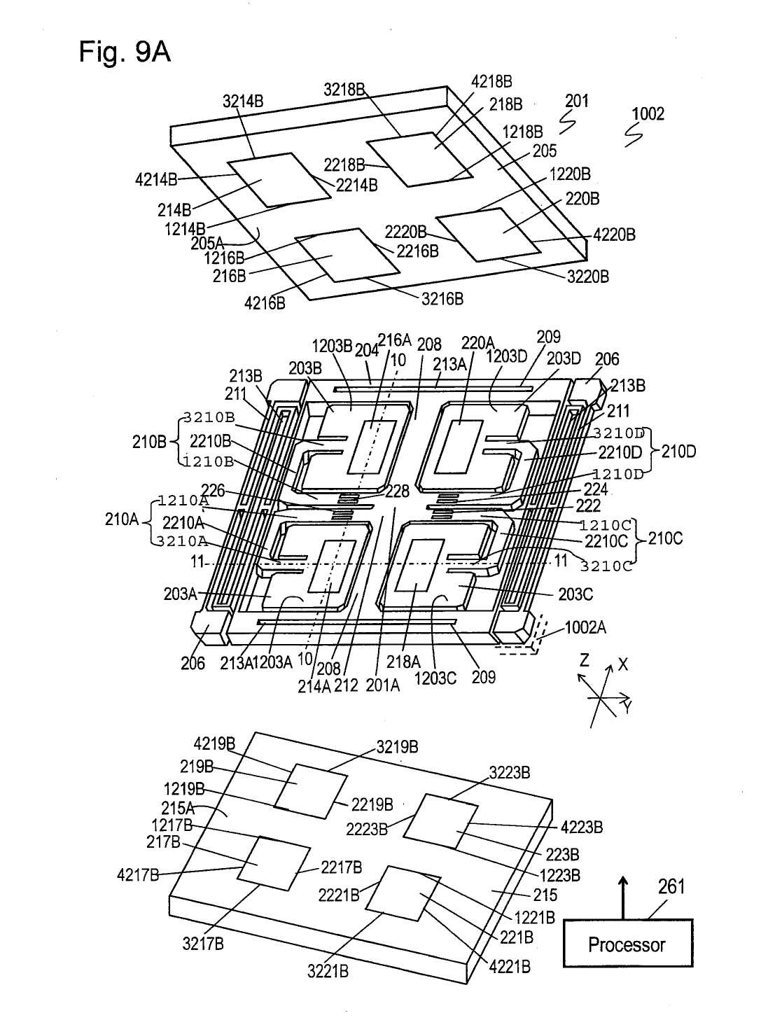

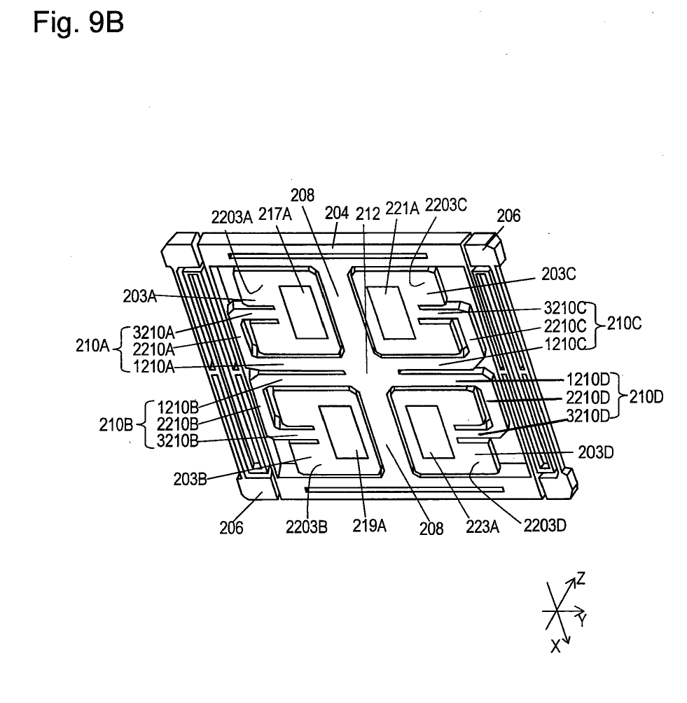

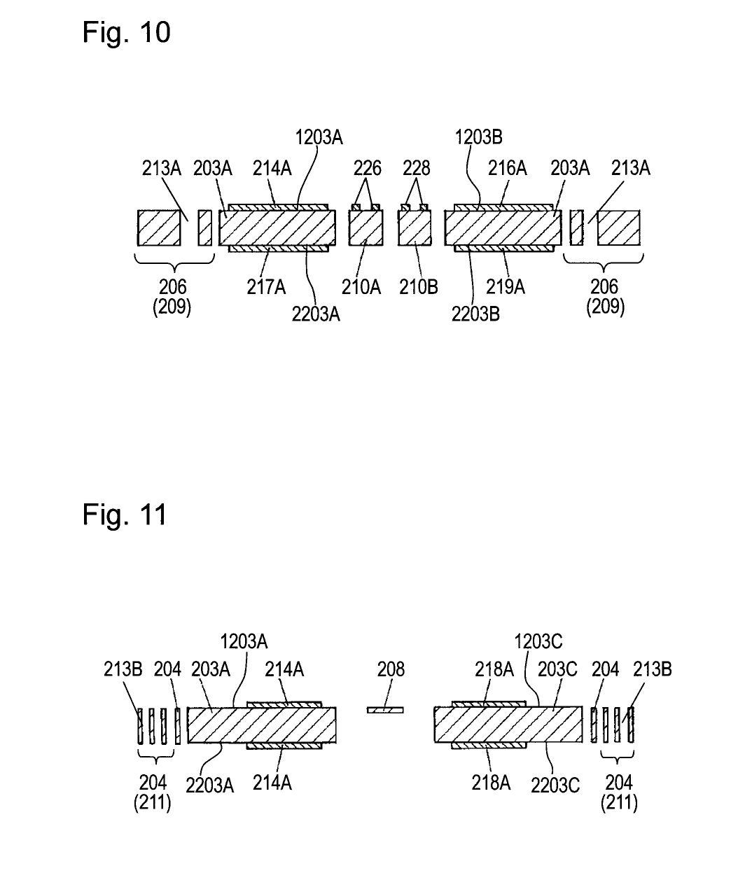

FIG. 9A is an exploded perspective view of sensor element 201 of inertial force sensor 1002 according to Exemplary Embodiment 2 of the present invention. FIG. 9B is a perspective view of sensor element 201. FIGS. 10 and 11 are sectional views of sensor element 201 on line 10-10 and line 11-11 shown in FIG. 9A, respectively. Inertial force sensor 1002 can detect an acceleration and an angular velocity.

A Z-axis, the X-axis, and the Y-axis, a first axis, a second axis, and a third axis perpendicular to each other, are defined as shown in FIGS. 9A and 9B. Two arms 208 extend from supporter 212 along the X-axis and connected to fixing portion 204 having a frame. Supporter 212 is joined to fixing portion 204 via arms 208. Arms 208 extend perpendicular to fixing portion 204. Four arms 210A to 210D extend from supporter 212 along the Y-axis and are connected to four weights 203A to 203D, respectively. Arms 208 and 210A to 210D are flexible and constitute a flexible portion together with supporter 212. The flexible portion is connected to fixing portion 204. Weights 203A to 203D are linked to fixing portion 204 via the flexible portion. Weights 203A to 203D have surfaces 1203A to 1203D facing substrate 205, and have surfaces 2203A to 2203D which face substrate 215 and which are opposite to surfaces 1203A to 1203D, respectively. Arms 208 are much thinner and hence more flexible than arms 210A to 210D.

Electrodes 214A, 216A, 218A and 220A are provided on surfaces 1203A, 1203B, 1203C, and 1203D of weights 203A, 203B, 203C, and 203D, respectively. Electrodes 217A, 219A, 221A, and 223A are provided on surfaces 2203A, 2203B, 2203C, and 2203D of weights 203A, 203B, 203C, and 203D, respectively. Substrates 205 and 215 are attached to fixing portion 204. Substrate 205 has surface 205A facing surfaces 1203A to 1203D of weights 203A to 203D along the Z-axis. Electrodes 214B, 216B, 218B, and 220B facing electrodes 214A, 216A, 218A and 220A along the Z-axis are provided on surface 205A of substrate 205, and are spaced from electrodes 214A, 216A, 218A and 220A, respectively. Electrodes 214A and 214B having a capacitance between the electrodes constitute opposed electrode unit 214. Electrodes 216A and 216B having a capacitance between the electrodes constitute opposed electrode unit 216. Electrodes 218A and 218B having a capacitance between the electrodes constitute opposed electrode unit 218. Electrodes 220A and 220B having a capacitance between the electrodes constitute opposed electrode unit 220. Electrodes 214A and 216A are arranged along the X-axis, and electrodes 214B and 216B are also arranged along the X-axis. Thus, opposed electrode units 214 and 216 are arranged along the X-axis. Electrodes 218A and 220A are arranged along the X-axis, and electrodes 218B and 220B are also arranged along the X-axis. Thus, opposed electrode units 218 and 220 are arranged along the X-axis. Electrodes 214A and 218A are arranged along the Y-axis, and electrodes 214B and 218B are also arranged along the Y-axis. Thus, opposed electrode units 214 and 218 are arranged along the Y-axis. Electrodes 216A and 220A are arranged along the Y-axis, and electrodes 216B and 220B are also arranged along the Y-axis. Thus, opposed electrode units 216 and 220 are arranged along the Y-axis. Substrate 215 has surface 215A facing surfaces 2203A to 2203D of weights 203A to 203D along the Z-axis. Electrodes 217B, 219B, 221B, and 223B facing electrodes 217A, 219A, 221A, and 223A along the Z-axis are provided on surface 215A of substrate 215 electrodes 217B, 219B, 221B, and 223B, and are spaced from electrodes 217A, 219A, 221A, and 223A, respectively. Electrodes 217A and 217B having a capacitance between the electrodes constitute opposed electrode unit 217. Electrodes 219A and 219B having a capacitance between the electrodes constitute opposed electrode unit 219. Electrodes 221A and 221B having a capacitance between the electrodes constitute opposed electrode unit 221. Electrodes 223A and 223B having a capacitance between the electrodes constitute opposed electrode unit 223. Electrodes 217A and 219A are arranged along the X-axis, and electrodes 217B and 219B are also arranged along the X-axis. Thus, opposed electrode units 217 and 219 are arranged along the X-axis. Electrodes 221A and 223A are arranged along the X-axis, and electrodes 221B and 223B are also arranged along the X-axis. Thus, opposed electrode units 221 and 223 are arranged along the X-axis. Electrodes 217A and 221A are arranged along the Y-axis, and electrodes 217B and 221B are also arranged along the Y-axis. Thus, opposed electrode units 217 and 221 are arranged along the Y-axis. Electrodes 219A and 223A are arranged along the Y-axis, and electrodes 219B and 223B are also arranged along the Y-axis. Thus, opposed electrode units 219 and 223 are arranged along the Y-axis.

Arm 210A extending from supporter 212 includes Extension 1210A extending from supporter 212 along the Y-axis, extension 3210A extending in parallel with extension 1210A along the Y-axis, and connecting portion 2210A connecting between extensions 1210A and 3210A, and thus, has substantially a U-shape. Connecting portion 2210A extends from extension 1210A along the X-axis. Extension 3210A is connected to weight 203A. Arm 210B extending from supporter 212 includes Extension 1210B extending from supporter 212 along the Y-axis, extension 3210B extending in parallel with extension 1210B along the Y-axis, and connecting portion 2210B connecting between extensions 1210B and 3210B, and thus, has substantially a U-shape. Connecting portion 2210B extends from extension 1210B along the X-axis in a direction opposite to connecting portion 2210A of arm 210A. Extension 3210B is connected to weight 203B. Arm 210C extending from supporter 212 includes Extension 1210C extending from supporter 212 along the Y-axis, extension 3210C extending in parallel with extension 1210C along the Y-axis, and connecting portion 2210C connecting between extensions 1210C and 3210C, and thus, has substantially a U-shape. Connecting portion 2210C extends from extension 1210C along the X-axis in a direction identical to the direction in which connecting portion 2210A of arm 210A extends. Extension 3210C is connected to weight 203C. Arm 210D extending from supporter 212 includes Extension 1210D extending from supporter 212 along the Y-axis, extension 3210D extending in parallel with extension 1210D along the Y-axis, and connecting portion 2210D connecting between extensions 1210D and 3210D, and thus, has substantially a U-shape. Connecting portion 2210D extends from extension 1210D along the X-axis in a direction opposite to connecting portion 2210C of arm 210C. Extension 3210D is connected to weight 203D. Extensions 1210A to 1210D and 3210A to 3210D of arms 210A to 210D extend perpendicularly to fixing portions 204 and 206.

Arms 208 and supporter 212 are arranged substantially in a single straight line. Extensions 1210A and 1210B of arms 210A and 210B extend in the same direction from supporter 212. Extensions 1210C and 1210D of arms 210C and 210D extend in the same direction from supporter 212 and in the direction opposite to the direction in which extensions 1210A and 1210B of arms 210A and 210B extend.

Weights 203A to 203D are arranged inside the frame shape of fixing portion 204. Fixing portion 204 is linked to fixing portion 206 via fixing arm 207, and placed inside fixing portion 206. Arms 208 and supporter 212 are arranged substantially in a single straight line, and arms 208 are arranged symmetrically to each other with respect to center 201A of sensor element 201. Arms 210A to 210D are arranged symmetrically to each other with respect to center 201A of sensor element 201. Arms 208 and 210A to 210D function as a linking unit for linking weights 203A to 203D to fixing portion 204. Fixing arm 207 functions as a linking unit for linking fixing portion 204 to fixing portion 206.

Fixing portion 204 includes elastic portions 209 which elastically deform only along the X-axis, that is, elastic portions 209 do not substantially deform along any of the Y-axis and the Z-axis. Fixing arm 207 extends along the Y-axis. Fixing portion 206 includes elastic portions 211 which elastically deform only along the Y-axis, that is, elastic portions 211 do not substantially deform along any of the X-axis and the Z-axis. Fixing portion 206 is arranged to be mounted to mounting substrate 1002A, an object.

Elastic portions 209 are implemented by slits 213A which are provided in fixing portion 204 and which extend along the Y-axis. Elastic portions 211 are implemented by slits 213B which are provided in fixing portion 206 and extend along the X-axis.

Driving electrode 222 is provided on arm 210C and drives and vibrates weight 203C. Detecting electrode 224 is provided on arm 210D and detects the vibration of arm 210D. Sensing electrodes 226 and 228 are provided on arms 210A and 210B, and sense the strains of arms 210A and 210B, respectively. Driving electrode 222 includes a lower electrode provided on arm 210C, a piezoelectric layer provided on the lower electrode, and an upper electrode provided on the piezoelectric layer. Similarly, each of detecting electrode 224 and sensing electrodes 226 and 228 include a lower electrode provided on each of arms 210D, 210A, and 210B, respectively, a piezoelectric layer provided on the lower electrode, and an upper electrode provided on the piezoelectric layer.

Opposed electrode units 214, 216, 217, 218, 219, 220, 221, and 223, driving electrode 222, detecting electrode 224, and sensing electrodes 226, 228 are connected out to fixing portion 206 via signal lines and electrically connected to circuit patterns on mounting substrate 1002A with, e.g. bonding wire at ends of the signal lines. Opposed electrode units 214, 216, 217, 218, 219, 220, 221, and 223, driving electrode 222, detecting electrode 224, and sensing electrodes 226, 228 are connected to processor 261 via the signal lines and mounting substrate 1002A.

Inertial force sensor 1002 including driving electrode 222, detecting electrode 224, and sensing electrodes 226, 228 can detect the angular velocity about the Z-axis similarly to inertial force sensor 1001 including driving electrode 122, detecting electrode 124, and sensing electrodes 126, 128 according to Embodiment 1 shown in FIG. 4.

An operation of inertial force sensor 1002 to detect an acceleration will be described.

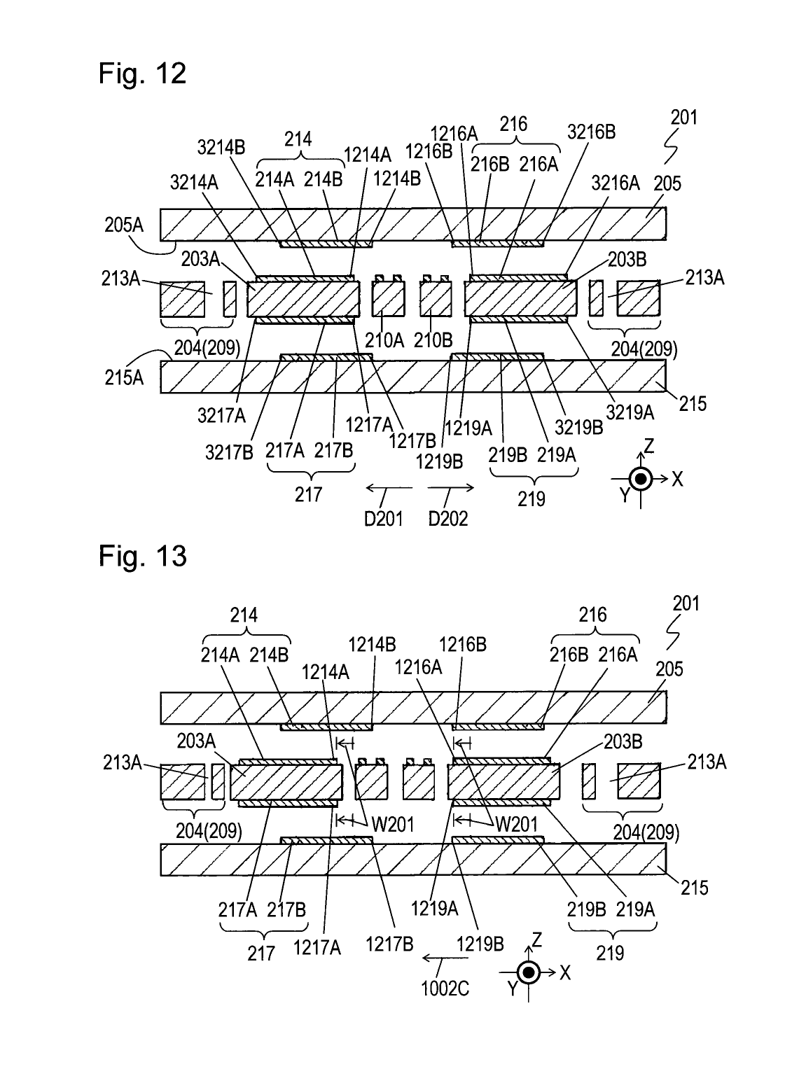

First, an operation of inertial force sensor 1002 to detect an acceleration along the X-axis will be described below. FIG. 12 is a sectional view of sensor element 201 on line 10-10 shown in FIG. 9A when no acceleration along the X-axis is applied. Electrodes 214A and 214B have ends 1214A and 1214B directed in the same direction along the X-axis. Electrodes 216A and 216B have ends 1216A and 1216B directed in the same direction along the X-axis and facing ends 1214A and 1214B, respectively. When no acceleration is applied, end 1214A of electrode 214A deviates slightly from end 1214B of electrode 214B in direction D201 along the X-axis, and end 1216A of electrode 216A deviates slightly from end 1216B of electrode 216B in direction D202 opposite to direction D201. Similarly, when no acceleration is applied, ends of electrodes 218A and 218B directed in the same direction deviate slightly from each other along the X-axis, and ends of electrodes 220A and 220B directed in the same direction deviate slightly from each other in a direction opposite to the direction in which the ends of electrodes 218A and 218B deviate along the X-axis. Electrodes 217A and 217B have ends 1217A and 1217B directed in the same direction, and electrodes 219A and 219B have ends 1219A and 1219B directed in the same direction and facing ends 1217A and 1217B, respectively. When no acceleration is applied, end 1217A of electrode 217A deviates slightly from end 1217B of electrode 217B in direction D201, and end 1219A of electrode 219A deviates slightly in direction D202. Similarly, when no acceleration is applied, ends of electrodes 221A and 221B directed in the same direction deviate slightly from each other along the X-axis, and ends of electrodes 223A and 223B directed in the same direction deviate slightly from each other in a direction opposite to the direction in which the ends of electrodes 221A and 221B deviate along the X-axis. Electrodes 214A and 214B have ends 3214A and 3214B opposite to ends 1214A and 1214B along the X-axis. When no acceleration is applied, end 3214A of electrode 214A deviates slightly from end 3214B of electrode 214B in direction D201 along the X-axis. Electrodes 216A and 216B have ends 3216A and 3216B opposite to ends 3216A and 3216B along the X-axis, respectively. When no acceleration is applied, end 3216A of electrode 216A deviates slightly from end 3216B of electrode 216B in direction D202. Electrodes 217A and 217B have ends 3217A and 3217B opposite to ends 1217A and 1217B along the X-axis, respectively. When no acceleration is applied, end 3217A of electrode 217A deviates slightly from end 3217B of electrode 217B in direction D201 along the X-axis. Electrodes 219A and 219B have ends 3219A and 3219B side opposite to ends 3219A and 3219B along the X-axis. When no acceleration is applied, end 3219A of electrode 219A deviates slightly from end 3219B of electrode 219B in direction D202.

FIG. 13 is a sectional view of sensor element 201 on line 10-10 shown in FIG. 9A when an acceleration along the X-axis is applied. When acceleration 1002C directed in direction D201 along the X-axis is applied, a force along the X-axis due to acceleration 1002C deforms elastic portions 209 along the X-axis but not along any of the Y-axis and the Z-axis while acceleration 1002C is not converted into a rotational force. The force displaces ends 1214A and 1216A of electrodes 214A and 216A relatively with respect to ends 1214B and 1216B of electrodes 214B and 216B by distance W201 along the X-axis. Similarly, the force displaces the ends of electrodes 218A and 220A relatively with respect to the ends of electrodes 218B and 220B by distance W201 along the X-axis. When weights 203A and 203B are displaced along the X-axis due to acceleration 1002C, the capacitance of opposed electrode unit 214 changes by an amount different from an amount of the change of the capacitance of opposed electrode unit 216. Similarly, when weights 203C and 203D are displaced along the X-axis, the capacitance of opposed electrode unit 218 changes by an amount different from an amount of the change of the capacitance of opposed electrode unit 220. Similarly, the force displaces ends 1217A and 1219A of electrodes 217A and 219A relatively with respect to ends 1217B and 1219B of electrodes 217B and 219B by distance W201 along the X-axis. Similarly, the ends of electrodes 221A and 223A are displaced relatively with respect to the ends of electrodes 221B and 223B by distance W201 along the X-axis. When weights 203A and 203B are displaced along the X-axis due to acceleration 1002C, the capacitance of opposed electrode unit 217 changes by an amount different from the amount of the change of the capacitance of opposed electrode unit 219. Similarly, when weights 203C and 203D are displaced along the X-axis, the capacitance of opposed electrode unit 221 changes by an amount different from the amount of the change of the capacitance of opposed electrode unit 223.

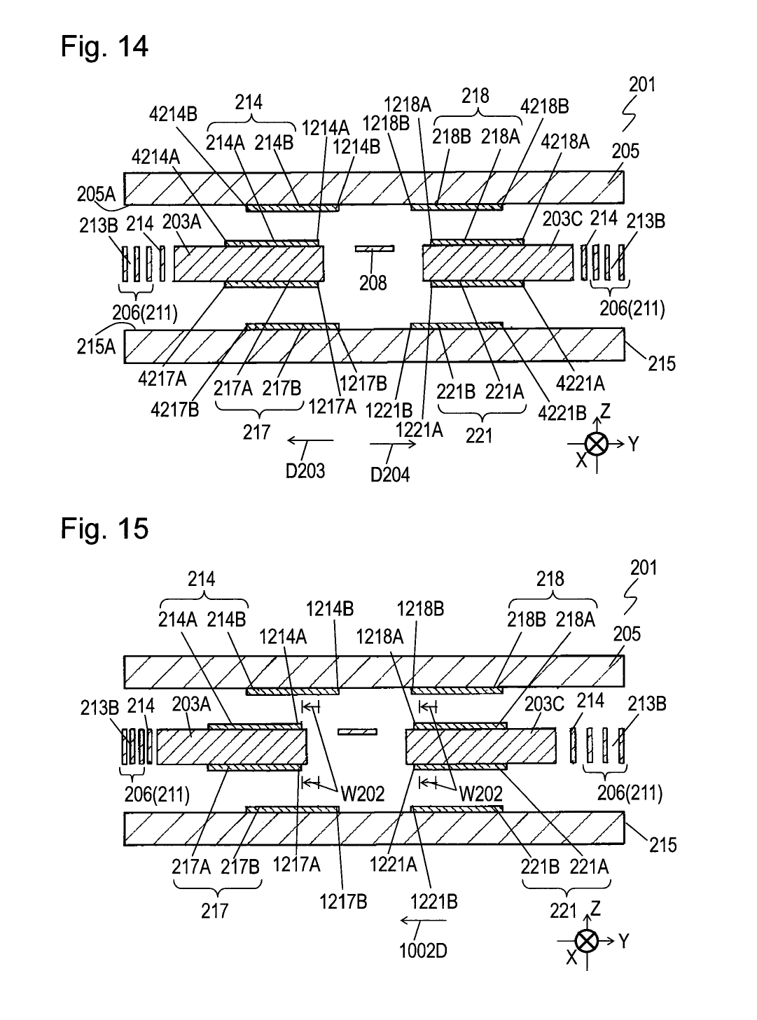

Next, an operation of inertial force sensor 1002 to detect the acceleration along the Y-axis will be described below. FIG. 14 is a sectional view of sensor element 201 on line 10-10 shown in FIG. 9A when no acceleration along the Y-axis is applied. Electrodes 214A and 214B have ends 2214A and 2214B directed in the same direction along the Y-axis, and electrodes 218A and 218B have ends 2218A and 2218B directed in the same direction along the Y-axis and facing ends 2214A and 2214B, respectively. When no acceleration is applied, end 2214A of electrode 214A deviates slightly from end 2214B of electrode 214B in direction D203 along the Y-axis, and end 2218A of electrode 218A deviates slightly from end 2218B of electrode 218B in direction D204 opposite to direction D203. Similarly, when no acceleration is applied, ends of electrodes 216A and 216B directed in the same direction deviate slightly from each other along the Y-axis, and ends of electrodes 220A and 220B directed in the same direction deviate slightly from each other in a direction opposite to the direction in which the ends of electrodes 218A and 218B deviate along the Y-axis. Electrodes 217A and 217B have ends 2217A and 2217B directed in the same direction, and electrodes 221A and 221B have ends 2221A and 2221B directed in the same direction and facing ends 2217A and 2217B, respectively. When no acceleration is applied, end 2217A of electrode 217A deviates slightly from end 2217B of electrode 217B in direction D203, and end 2221A of electrode 221A deviates slightly in direction D204. Similarly, when no acceleration is applied, the ends of electrodes 219A and 219B directed in the same direction deviate slightly from each other along the Y-axis, and the ends of electrodes 223A and 223B directed in the same direction deviate slightly from each other in the direction opposite to the direction in which the ends of electrodes 219A and 219B deviate along the Y-axis. Electrodes 214A and 214B have ends 4214A and 4214B opposite to ends 2214A and 2214B along the Y-axis. When no acceleration is applied, end 4214A of electrode 214A deviates slightly from end 4214B of electrode 214B in direction D203 along the Y-axis. Electrodes 218A and 218B have ends 4218A and 4218B opposite to ends 2218A and 2218B along the Y-axis. When no acceleration is applied, end 4218A of electrode 218A deviates slightly from end 4218B of electrode 218B in direction D204. Electrodes 217A and 217B have ends 4217A and 4217B opposite to ends 2217A and 2217B along the Y-axis. When no acceleration is applied, end 4217A of electrode 217A deviates slightly from end 4217B of electrode 217B in direction D203 along the Y-axis. Electrodes 221A and 221B have ends 4221A and 4221B opposite to ends 2221A and 2221B along the Y-axis. When no acceleration is applied, end 4221A of electrode 221A deviates slightly from end 4221B of electrode 221B in direction D204.

FIG. 15 is a sectional view of sensor element 201 on line 10-10 shown in FIG. 9A when an acceleration along the Y-axis is applied. When acceleration 1002D directed in direction D203 along the Y-axis is applied, a force along the Y-axis due to acceleration 1002D deforms elastic portions 209 along the Y-axis but not along any of the Y-axis and the Z-axis while the force is not converted into a rotational force. The force displaces ends 2214A and 2218A of electrodes 214A and 218A relatively with respect to ends 2214B and 2218B of electrodes 214B and 218B by distance W202 along the Y-axis. Similarly, the force displaces the ends of electrodes 216A and 220A relatively with respect to the ends of electrodes 216B and 220B by distance W202 along the Y-axis. When weights 203A and 203C are displaced along the Y-axis due to acceleration 1002D, the capacitance of opposed electrode unit 214 changes by an amount different from an amount of the change of the capacitance of opposed electrode unit 218. Similarly, when weights 203B and 203D are displaced along the Y-axis, the capacitance of opposed electrode unit 216 changes by an amount different from an amount of the change of the capacitance of opposed electrode unit 220. Similarly, the force displaces ends 2217A and 2221A of electrodes 217A and 221A relatively with respect to ends 2217B and 2221B of electrodes 217B and 221B by distance W202 along the Y-axis. Similarly, the force displaces the ends of electrodes 219A and 223A relatively with respect to the ends of electrodes 219B, 223B by distance W202 along the Y-axis. When weights 203A and 203C are along the Y-axis due to acceleration 1002D, the capacitance of opposed electrode unit 217 changes by an amount different from an amount of the change of the capacitance of opposed electrode unit 221. Similarly, when weights 203B and 203D are displaced along the Y-axis, the capacitance of opposed electrode unit 219 changes by an amount different from an amount of the change of the capacitance of opposed electrode unit 223.

Thus, accelerations 1002C and 1002D along the X-axis and the Y-axis changes the capacitances of opposed electrode units 214, 216, 217, 218, 219, 220, 221, and 223. Processor 261 can detect accelerations 1002C and 1002D based on the changes of the capacitances.

Sensor element 201 can detect acceleration 1002C along the X-axis since elastic portions 209 deform along the X-axis but not along any of the Y-axis and the Z-axis. Sensor element 201 can detect acceleration 1002D along the Y-axis since elastic portions 211 deform along the Y-axis but not along any of the X-axis and the Z-axis. Thus, sensor element 201 can detect acceleration 1002C along the X-axis and acceleration 1002D along the Y-axis at high sensitivity independently without mutual interference.

Acceleration 1002C changes the capacitances of opposed electrode units 214 and 216 by the amounts different from each other, and changes the capacitances of opposed electrode units 218 and 220 by the amounts different from each other. Acceleration 1002C changes the capacitances of opposed electrode units 217 and 219 by the amounts different from each other, and changes the capacitances of opposed electrode units 221 and 223 by the amounts different from each other. For example, when acceleration 1002C directed in the negative direction of the X-axis is applied, as shown in FIG. 13, opposed electrode units 214, 217, 218, and 221 decrease their capacitances, and opposed electrode units 216, 219, 219, and 223 increase their capacitances. When an acceleration directed in the positive direction of the X-axis is applied, weights 203A to 203D are displaced in a direction opposite to the direction shown in FIG. 13. Therefore, opposed electrode units 214, 217, 218, and 221 increase their capacitances, and opposed electrode units 216, 219, 220, and 223 decrease their capacitances. Processor 261 connected to sensor element 201 can determine, based on the capacitances of opposed electrode units 214, 216, 217, 218, 219, 220, 221, and 223, whether weights 203A to 203D are displaced in the positive direction or the negative direction of the X-axis. Similarly, when acceleration 1002D directed in the negative direction of the Y-axis is applied, as shown in FIG. 15, opposed electrode units 214, 217, 216, and 219 decrease their capacitances, and opposed electrode units 218, 220, 221, and 223 increase their capacitances. When an acceleration directed in the positive direction of the Y-axis is applied, weights 203A to 203D are displaced in a direction opposite to the direction shown in FIG. 15. Therefore, opposed electrode units 214, 217, 216, and 219 increase their capacitances, and opposed electrode units 218, 220, 221, and 223 decrease their capacitances. Processor 261 can determine, based on the capacitances of opposed electrode units 214, 216, 217, 218, 219, 220, 221, and 223, whether weights 203A to 203D are displaced in the positive direction or the negative direction of the Y-axis.

In inertial force sensor 1002, when weights 203A to 203D are displaced in the positive direction of the Z-axis, electrodes 214A, 216A, 218A, and 220A approach electrodes 214B, 216B, 218B, and 220B, whereas electrodes 217A, 219A, 221A and 223A are displaced away from electrodes 217B, 219B, 221B, and 223B. When weights 203A to 203D are displaced in the negative direction of the Z-axis, electrodes 214A, 216A, 218A, and 220A are displaced away from electrodes 214B, 216B, 218B, and 220B, whereas electrodes 217A, 219A, 221A, and 223A approach electrodes 217B, 219B, 221B, and 223B. Thus, the displacement of weights 203A to 203D along the Z-axis does not change the sum of the distance between electrodes 214A and 214B and the distance between electrodes 217A and 217B, the sum of the distance between electrodes 216A and 216B and the distance between electrodes 219A and 219B, the sum of the distance between electrodes 218A and 218B and the distance between electrodes 221A and 221B, and the sum of the distance between electrodes 220A and 220B and the distance between electrodes 223A and 223B. Thus, the displacement of weights 203A to 203D along the Z-axis does not change a combined capacitance of opposed electrode units 214 and 217, a combined capacitance of opposed electrode units 216 and 219, a combined capacitance of opposed electrode units 218 and 221, or a combined capacitance of opposed electrode units 220 and 223 so much. Thus, inertial force sensor 1002 can detect accelerations 1002C and 1002D accurately based on these combined capacitances.

Single sensor element 201 which can detect both the acceleration and the angular velocity allows inertial force sensor 1002 to have a small footprint and a small size.

Elastic portions 209 which deform along the X-axis but not along any of the Y-axis and the Z-axis are placed at fixing portion 204 of sensor element 201 of inertial force sensor 1002. Alternatively, elastic portions 209 may be placed at arms 208 functioning as the linking unit of the inertial force sensor according to Embodiment 2. Elastic portions 211 which deform along the Y-axis but not along any of the X-axis and the Z-axis are placed at fixing portion 206 of sensor element 201. Alternatively, elastic portions 211 may be placed at fixing arm 207 functioning as the linking unit of the inertial force sensor according to Embodiment 2.

Driving electrode 222, detecting electrode 224, and sensing electrodes 226 and 228 for detecting the angular velocity may have shapes and positions other than those described above.

Electrodes 214A, 216A, 217A, 218A, 219A, 220A, 221A, and 223A are largely displaced in the direction of the acceleration with respect to electrodes 214B, 216B, 217B, 218B, 219B, 220B, 221B, and 223B without causing the force due to the acceleration to be converted into a rotational force. Thus, inertial force sensor 1002 according to Embodiment 2 detects the acceleration at high sensitivity.

### Exemplary Embodiment 3

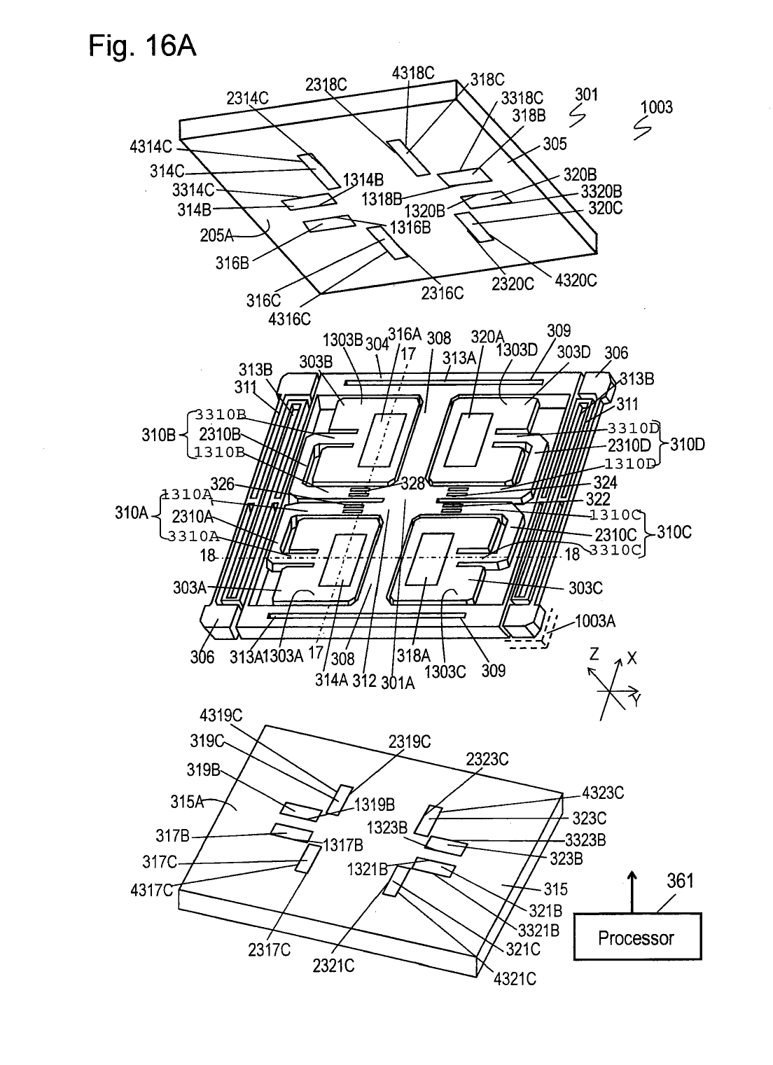

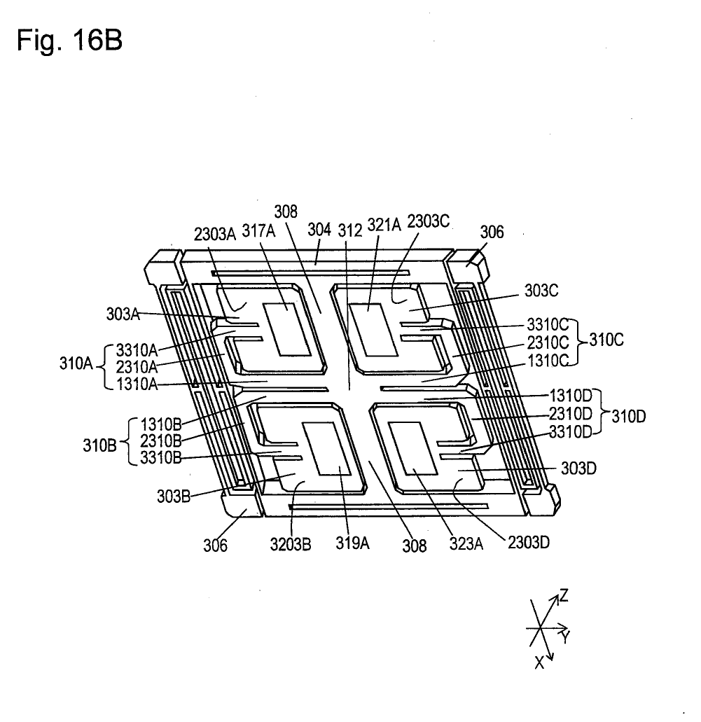

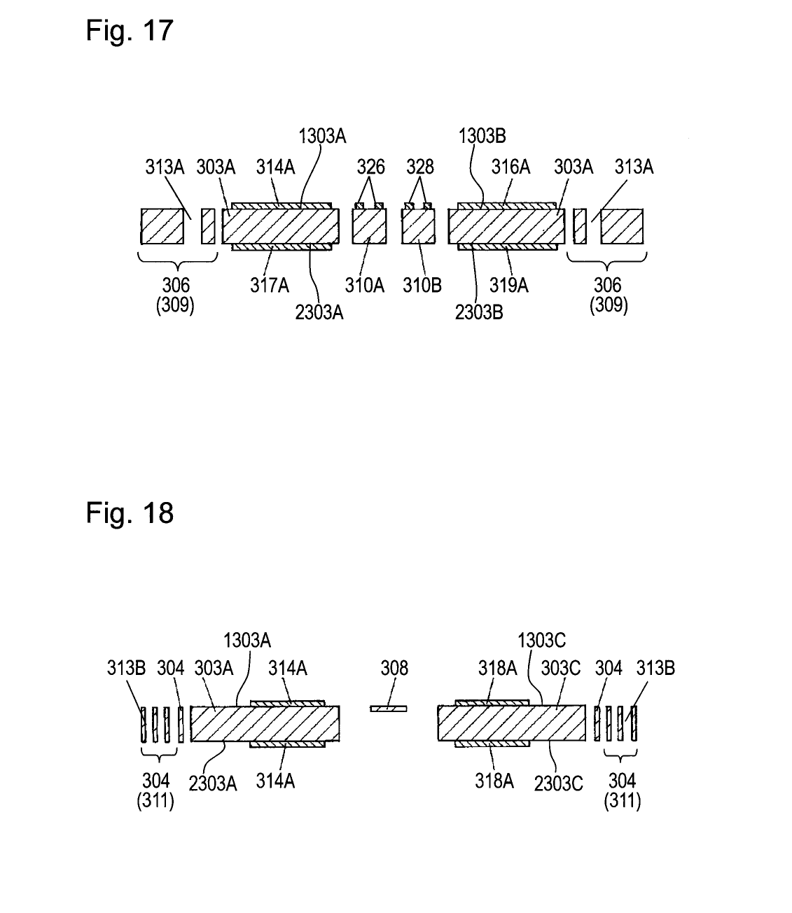

FIG. 16A is an exploded perspective view of sensor element 301 of inertial force sensor 1003 according to Exemplary Embodiment 3 of the present invention. FIG. 16B is a perspective view of sensor element 301. FIGS. 17 and 18 are sectional views of sensor element 301 on line 17-17 and line 18-18 shown in FIG. 16A, respectively. Inertial force sensor 1003 can detect an acceleration and an angular velocity.

A Z-axis, an X-axis, and a Y-axis, a first axis, a second axis, and a third axis perpendicular to each other are defined as shown in FIGS. 16A and 16B. Two arms 308 extend from supporter 312 along the X-axis and are connected to fixing portion 304 having a frame shape. Supporter 312 is joined to fixing portion 304 via arms 308. Arms 308 extend perpendicularly to fixing portion 304. Four arms 310A to 310D extend from supporter 312 along the Y-axis and are connected to four weights 303A to 303D, respectively.

Arms 308 and 310A to 310D and supporter 312 are flexible and constitute a flexible portion. The flexible portion is connected to fixing portion 304. Weights 303A to 303D are linked to fixing portion 304 via the flexible portion. Weights 303A to 303D have surfaces 1303A to 1303D facing substrate 305, and have surfaces 2303A to 2303D which face substrate 315 and which are opposite to surfaces 1303A to 1303D, respectively. Arms 308 are much thinner and hence more flexible than arms 310A to 310D.

Electrodes 314A, 316A, 318A and 320A are provided on surfaces 1303A, 1303B, 1303C, and 1303D of weights 303A, 303B, 303C, and 303D, respectively. Electrodes 317A, 319A, 321A and 323A are provided on surfaces 2303A, 2303B, 2303C, and 2303D of weights 303A, 303B, 303C, and 303D, respectively. Substrates 305 and 315 are attached to fixing portion 304. Substrate 305 has surface 305A facing surfaces 1303A to 1303D of weights 303A to 303D along the Z-axis. Electrodes 314B, 316B, 318B, and 320B facing electrodes 314A, 316A, 318A, and 320A, along the Z-axis are provided on surface 305A of substrate 305 and are spaced from electrodes 314B, 316B, 318B, and 320B, respectively. Electrodes 314C, 316C, 318C, and 320C facing electrodes 314A, 316A, 318A, and 320A along the Z-axis are provided on substrate 305 and are spaced from electrodes 314A, 316A, 318A, and 320A, respectively. Electrodes 314A and 314B having a capacitance between the electrodes constitute opposed electrode unit 314X. Electrodes 316A and 316B having a capacitance between the electrodes constitute opposed electrode unit 316X. Electrodes 318A and 318B having a capacitance between the electrodes constitute opposed electrode unit 318X. Electrodes 320A and 320B having a capacitance between the electrodes constitute opposed electrode unit 320X. Electrodes 314A and 316A are arranged along the X-axis, and electrodes 314B and 316B are also arranged along the X-axis. Thus, opposed electrode units 314X and 316X are arranged along the X-axis. Electrodes 318A and 320A are arranged along the X-axis, and electrodes 318B and 320B are also arranged along the X-axis. Thus, opposed electrode units 318X and 320X are arranged along the X-axis. Electrodes 314A and 314C having a capacitance between the electrodes constitute opposed electrode unit 314Y. Electrodes 316A and 316C having a capacitance between the electrodes constitute opposed electrode unit 316Y. Electrodes 318A and 318C having a capacitance between the electrodes constitute opposed electrode unit 318Y. Electrodes 320A and 320C having a capacitance between the electrodes constitute opposed electrode unit 320Y. Electrodes 314A and 318A are arranged along the Y-axis, and electrodes 314C and 318C are also arranged along the Y-axis. Thus, opposed electrode units 314Y and 318Y are arranged along the Y-axis. Electrodes 316A and 320A are arranged along the Y-axis, and electrodes 316C and 320C are also arranged along the Y-axis. Thus, opposed electrode units 316Y and 320Y are arranged along the Y-axis. Substrate 315 has surface 315A facing surfaces 2303A to 2303D of weights 303A to 303D along the Z-axis. Electrodes 317B, 319B, 321B, and 323B facing electrodes 317A, 319A, 321A, and 323A along the Z-axis are provided on surface 315A of substrate 315 electrodes 317B, 319B, 321B, and 323B, and are spaced from electrodes 317A, 319A, 321A, and 323A, respectively. Electrodes 317C, 319C, 321C, and 323C facing electrodes 317A, 319A, 321A, and 323A along the Z-axis are provided on substrate 315 and are spaced from electrodes 317C, 319C, 321C, and 323C, respectively. Electrodes 317A and 317B having a capacitance between the electrodes constitute opposed electrode unit 317X. Electrodes 319A and 319B having a capacitance between the electrodes constitute opposed electrode unit 319X. Electrodes 321A and 321B having a capacitance between the electrodes constitute opposed electrode unit 321X. Electrodes 323A and 323B having a capacitance between the electrodes constitute opposed electrode unit 323X. Electrodes 317A and 319A are arranged along the X-axis, and electrodes 317B and 319B are arranged along the X-axis. Thus, opposed electrode units 317X and 319X are arranged along the X-axis. Electrodes 321A and 323A are arranged along the X-axis, and electrodes 321B and 323B are arranged along the X-axis. Thus, opposed electrode units 321X and 323X are arranged along the X-axis. Electrodes 317A and 317C having a capacitance between the electrodes constitute opposed electrode unit 317Y. Electrodes 319A and 319C having a capacitance between the electrodes constitute opposed electrode unit 319Y. Electrodes 321A and 321C having a capacitance between the electrodes constitute opposed electrode unit 321Y. Electrodes 323A and 323C having a capacitance between the electrodes constitute opposed electrode unit 323Y. Electrodes 317A and 321A are arranged along the Y-axis, and electrodes 317C and 321C are arranged along the Y-axis. Thus, opposed electrode units 317Y and 321Y are arranged along the Y-axis. Electrodes 319A and 333A are arranged along the Y-axis, and electrodes 319C, 323C are also arranged along the Y-axis. Thus, opposed electrode units 319Y and 323Y are arranged along the Y-axis.

Arm 310A extending from supporter 312 includes extension 1310A extending from supporter 312 along the Y-axis, extension 3310A extending in parallel with extension 1310A along the Y-axis, and connecting portion 2310A connecting between extensions 1310A and 3310A, and thus has substantially a U-shape. Connecting portion 2310A extends from extension 1310A along the X-axis. Extension 3310A is connected to weight 303A. Arm 310B extending from supporter 312 includes extension 1310B extending from supporter 312 along the Y-axis, extension 3310B extending in parallel with extension 1310B along the Y-axis, and connecting portion 2310B connecting between extensions 1310B and 3310B, and thus, has substantially a U-shape. Connecting portion 2310B extends from extension 1310B along the X-axis in a direction opposite to the direction in which connecting portion 2310A of arm 310A extends. Extension 3310B is connected to weight 303B. Arm 310C extending from supporter 312 includes extension 1310C extending from supporter 312 along the Y-axis, extension 3310C extending in parallel with extension 1310C along the Y-axis, and connecting portion 2310C connecting between extensions 1310C and 3310C, and thus, has substantially a U-shape. Connecting portion 2310C extends from extension 1310C along the X-axis in a direction identical to the direction in which connecting portion 2310A of arm 310A extends. Extension 3310C is connected to weight 303C. Arm 310D extending from supporter 312 includes extension 1310D extending from supporter 312 along the Y-axis, extension 3310D extending in parallel with extension 1310D along the Y-axis, and connecting portion 2310D connecting between extensions 1310D and 3310D, and thus, has substantially a U-shape. Connecting portion 2310D extends from extension 1310D along the X-axis in a direction opposite to the direction in which connecting portion 2310C of arm 310C extends. Extension 3310D is connected to weight 303D. Extensions 1310A to 1310D and 3310A to 3310D of arms 310A to 310D extend perpendicularly to fixing portions 304 and 306.

Arms 308 and supporter 312 are arranged substantially in a single straight line. Extension 1310A and 1310B of arms 310A and 310B extend in the same direction from supporter 312.

Extensions 1310C and 1310D of arms 310C and 310D extend in the same direction from supporter 312, and in the direction opposite to extensions 1310A and 1310B of arms 310A and 310B extends.

Weights 303A to 303D are arranged inside the frame shape of fixing portion 304. Fixing portion 304 is linked to fixing portion 306 via fixing arm 307, and placed inside fixing portion 306. Arms 308 and supporter 12 are arranged substantially in a single straight line. Arms 308 are arranged symmetrically to each other with respect to center 301A of sensor element 301. Arms 310A to 310D are arranged symmetrically to each other with respect to center 301A of sensor element 301. Arms 308 and 310A to 310D function as a linking unit for linking weights 303A to 303D to fixing portion 304. Fixing arm 307 functions as a linking unit for linking fixing portion 304 to fixing portion 306.

Fixing portion 304 includes elastic portions 309 which elastically deform only along the X-axis, that is, which do not substantially deform along any of the Y-axis and the Z-axis. Fixing arm 307 extends along the Y-axis. Fixing portion 306 includes elastic portions 311, which elastically deform only along the Y-axis, that is, which do not substantially deform along the X or Z-axis. Fixing portion 306 is arranged to be mounted to mounting substrate 1003A, an object.

Elastic portions 309 are implemented by slits 313A which are provided in fixing portion 304 and extend along the Y-axis. Elastic portions 311 are implemented by slits 313B which are provided in fixing portion 306 and which extend along the X-axis. Driving electrode 322 which drives and vibrates weight 303C is provided on arm 310C. Detecting electrode 324 which detects the vibration of arm 310D is provided on arm 310D. Sensing electrodes 326 and 328 which sense strains on arms 310A and 310B are provided on arms 310A and 310B, respectively. Driving electrode 322 includes a lower electrode provided on arm 310C, a piezoelectric layer provided on the lower electrode, and an upper electrode provided on the piezoelectric layer. Similarly, each of detecting electrodes 324, 326, and 328 include a lower electrode provided on each of arms 310D, 310A, and 310B, respectively, a piezoelectric layer provided on the lower electrode, and an upper electrode provided on the piezoelectric layer.

Opposed electrode units 314X, 314Y, 316X, 316Y, 317X, 317Y, 318X, 318Y, 319X, 319Y, 320X, 320Y, 321X, 321Y, 323X, and 323Y, driving electrode 322, detecting electrode 324, and sensing electrodes 326, 328 are connected to fixing portion 306 via signal lines, and electrically connected to circuit patterns on mounting substrate 1003A with e.g., bonding wire at ends of the signal lines. Opposed electrode units 314X, 314Y, 316X, 316Y, 317X, 317Y, 318X, 318Y, 319X, 319Y, 320X, 320Y, 321X, 321Y, 323X, and 323Y, driving electrode 322, detecting electrode 324, and sensing electrodes 326 and 328 are connected to processor 361 via the signal lines and mounting substrate 1003A.

Inertial force sensor 1003 including driving electrode 322, detecting electrode 324, and sensing electrodes 326, 328 can detect an angular velocity about the Z-axis similarly to inertial force sensor 1001 including driving electrode 122, detecting electrode 124, and sensing electrodes 126 and 128 according to Embodiment 1 shown in FIG. 4.

An operation of inertial force sensor 1002 to detect an acceleration will be described below.

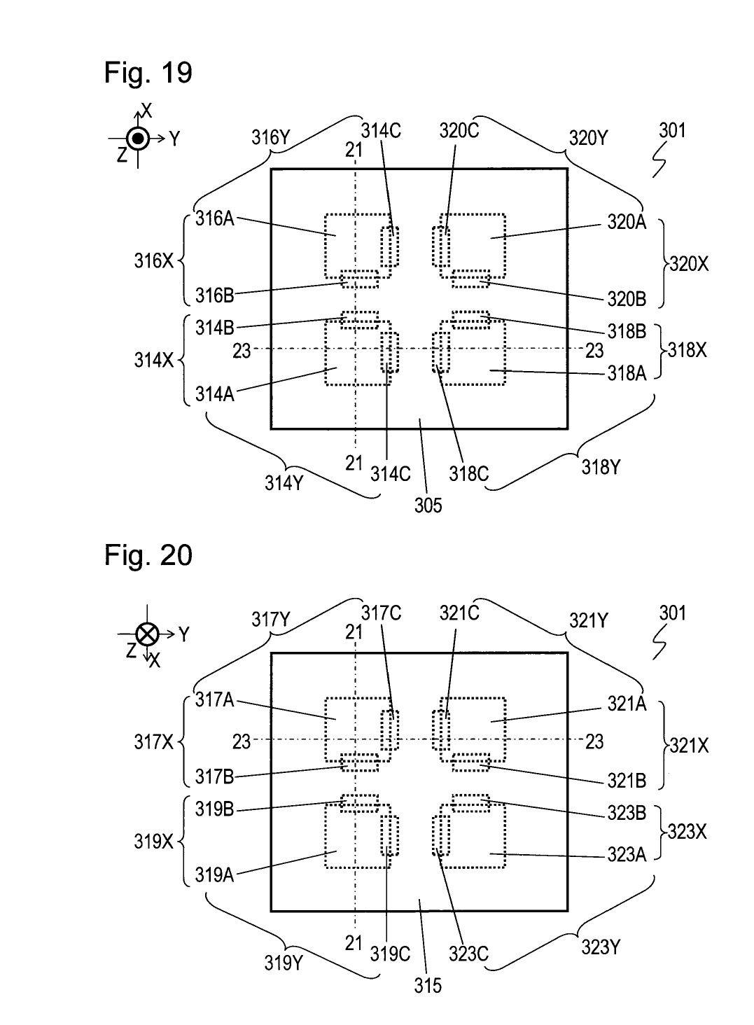

FIGS. 19 and 20 are plan views of sensor element 301. FIG. 19 shows positional relationship of electrodes 314A, 314B, 314C, 316A, 316B, 316C, 318A, 318B, 318C, 320A, 320B, and 320C. FIG. 20 shows positional relationship of electrodes 317A, 317B, 317C, 319A, 319B, 319C, 321A, 321B, 321C, 323A, 323B, and 323C.

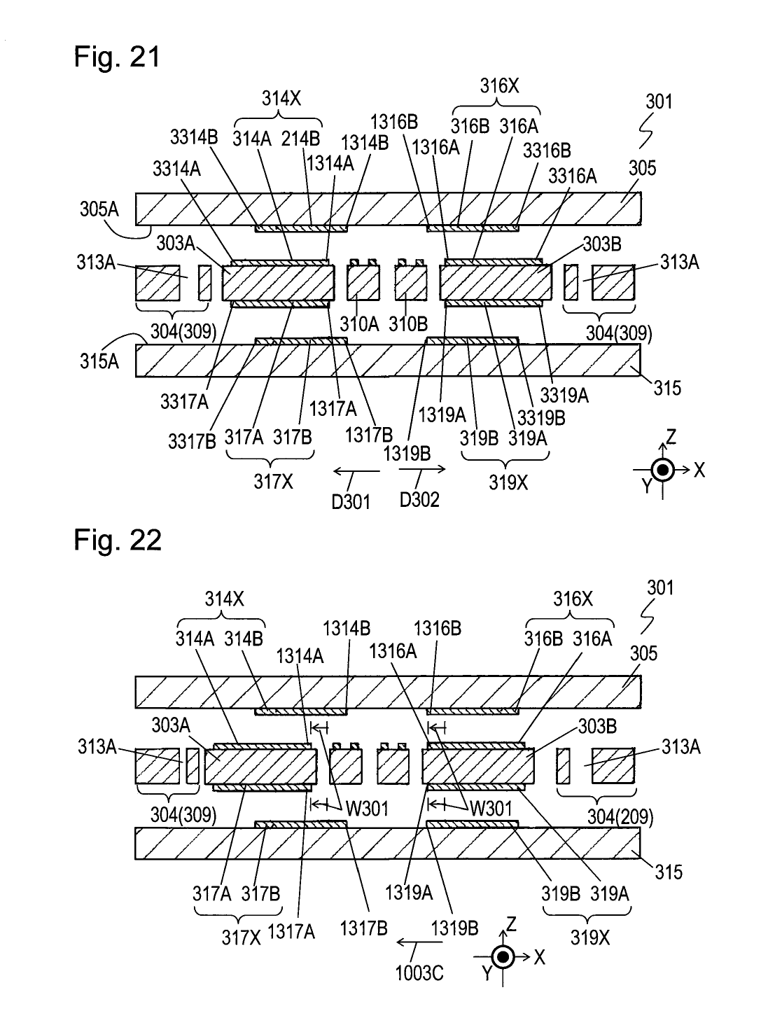

First, an operation of inertial force sensor 1003 to detect an acceleration along the X-axis will be described below. FIG. 21 is a sectional view of sensor element 301 on line 21-21 shown in FIGS. 19 and 20 when there no acceleration along the X-axis is applied. Electrodes 314A and 314B have ends 1314A and 1314B directed in the same direction along the X-axis. Electrodes 316A and 316B have ends 1316A and 1316B directed in the same direction along the X-axis and facing ends 1314A and 1314B, respectively. When no acceleration is applied, ends 1314A of electrode 314A deviates slightly from end 1314B of electrode 314B in direction D301 along the X-axis, and end 1316A of electrode 316A deviates slightly from end 1316B of electrode 316B in direction D302 opposite to direction D301. Similarly, electrodes 318A and 318B have ends 1318A and 1318B directed in the same direction along the X-axis, and electrodes 320A and 320B have ends 1320A and 1320B directed in the same direction along the X-axis and facing ends 1318A and 1318B, respectively. When no acceleration is applied, end 1318A of electrode 318A deviates slightly from end 1318B of electrode 318B in direction D301 along the X-axis, and end 1320A of electrode 320A deviates slightly from end 1320B of electrode 320B in direction D302.

Electrodes 317A and 317B have ends 1317A and 1317B directed in the same direction. Electrodes 319A and 319B have ends 1319A and 1319B directed in the same direction and facing ends 1317A and 1317B, respectively. When no acceleration is applied, end 1317A of electrode 317A deviates slightly from end 1317B of electrode 317B in direction D301, and end 1319A of electrode 319A deviates slightly in direction D302. Similarly, electrodes 321A and 321B have ends 1321A and 1321B directed in the same direction. Electrodes 323A and 323B have ends 1323A and 1323B directed in the same direction and facing ends 1321A and 1321B. When no acceleration is applied, end 1321A of electrode 321A deviates slightly from end 1321B of electrode 321B in direction D301, and end 1323A of electrode 323A deviates slightly in direction D302. Electrodes 314A and 314B have ends 3314A and 3314B opposite to ends 1314A and 1314B along the X-axis, respectively. When no acceleration is applied, end 3314A of electrode 314A deviates slightly from end 3314B of electrode 314B in direction D301 along the X-axis. Electrodes 316A and 316B have ends 3316A and 3316B opposite to ends 3316A and 3316B along the X-axis, respectively. When no acceleration is applied, end 3316A of electrode 316A deviates slightly from end 3316B of electrode 316B in direction D302. Electrodes 317A and 317B have ends 3317A and 3317B opposite to ends 1317A and 1317B along the X-axis, respectively. When no acceleration is applied, end 3317A of electrode 317A deviates slightly from end 3317B of electrode 317B in direction D301 along the X-axis. Electrodes 319A and 319B have ends 3319A and 3319B opposite to ends 3319A and 3319B along the X-axis, respectively. When no acceleration is applied, end 3319A of electrode 319A deviates slightly from end 3319B of electrode 319B in direction D302.

FIG. 22 is a sectional view of sensor element 301 on line 21-21 shown in FIGS. 19 and 20 when an acceleration along the X-axis is applied. When acceleration 1003C directed in direction D301 along the X-axis is applied, a force along the X-axis due to acceleration 1003C deforms elastic portions 309 along the X-axis nut not along any of the Y-axis and the Z-axis while the force is not converted into a rotational force. The force displaces ends 1314A and 1316A of electrodes 314A and 316A relatively with respect to ends 1314B and 1316B of electrodes 314B and 316B by distance W301 along the X-axis. Similarly, the force displaces ends of electrodes 318A and 320A relatively with respect to ends of electrodes 318B and 320B by distance W301 along the X-axis. When weights 303A and 303B are displaced along the X-axis due to acceleration 1003C, the capacitance of opposed electrode unit 314X changes by an amount different from an amount of the change of the capacitance of opposed electrode unit 316X. Similarly, when weights 303C and 303D are displaced along the X-axis, the capacitance of opposed electrode unit 318X changes by an amount different from an amount of the change of the capacitance of opposed electrode unit 320X. Similarly, the force displaces ends 1317A and 1319A of electrodes 317A and 319A relatively with respect to ends 1317B and 1319B of electrodes 317B and 319B by distance W301 along the X-axis. Similarly, the force displaces ends of electrodes 321A and 323A relatively with respect to the ends of electrodes 321B and 323B by distance W301 along the X-axis. When weights 303A and 303B are displaced along the X-axis due to acceleration 1003C, the capacitance of opposed electrode unit 317X changes by an amount different from an amount of the change of the capacitance of opposed electrode unit 319X. Similarly, when weights 303C and 303D are displaced along the X-axis, the capacitance of opposed electrode unit 321X changes by an amount different from an amount of the change of the capacitance of opposed electrode unit 323X.

Processor 361 detects acceleration 1003C along the X-axis based on the amount of the change of the difference between a combined capacitance of opposed electrode units 314X, 318X, 317X, and 321X and a combined capacitance of opposed electrode units 316X, 320X, 319X, and 323X.

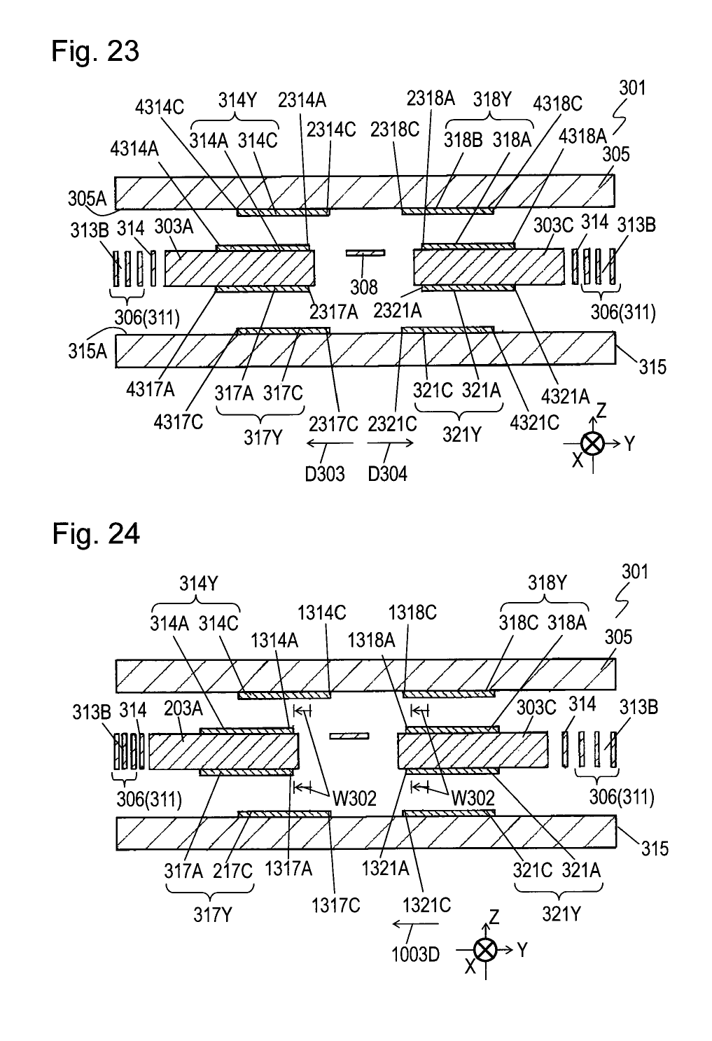

Next, an operation of inertial force sensor 1003 to detect an acceleration along the Y-axis will be described below. FIG. 23 is a sectional view of sensor element 301 on line 23-23 shown in FIGS. 19 and 20 when no acceleration along the Y-axis is applied. Electrodes 314A and 314C have ends 2314A and 2314C directed in the same direction along the Y-axis. Electrodes 316A and 316C have ends 2316A and 2316C directed in the same direction along the Y-axis and facing ends 2314A and 2314C, respectively. When no acceleration is applied, end 2314A of electrode 314A deviates slightly from end 2314C of electrode 314C in direction D303 along the Y-axis, and end 2316A of electrode 316A deviates slightly from end 2316C of electrode 316C in direction D304 opposite to direction D303. Similarly, electrodes 318A and 318C have ends 2318A and 2318C directed in the same direction along the Y-axis. Electrodes 320A and 320C have ends 2320A and 2320C directed in the same direction along the Y-axis and facing ends 2318A and 2318C. When no acceleration is applied, end 2318A of electrode 318A deviates slightly from end 2318C of electrode 318C in direction D303 along the Y-axis, and end 2320A of electrode 320A deviates slightly from end 2320C of electrode 320C in direction D304. Electrodes 317A and 317C have ends 2317A and 2317C directed in the same direction. Electrodes 319A and 319C have ends 2319A and 2319C directed in the same direction face ends 2317A and 2317C, respectively. When no acceleration is applied, end 2317A of electrode 317A deviates slightly from end 2317C of electrode 317C in direction D303, and end 2319A of electrode 319A deviates slightly in direction D304. Similarly, electrodes 321A and 321C have ends 2321A and 2321C directed in the same direction. Electrodes 323A and 323C have ends 2323A and 2323C directed in the same direction face ends 2321A and 2321C, respectively. When no acceleration is applied, end 2321A of electrode 321A deviates slightly from end 2321C of electrode 321C in direction D303, and end 2323A of electrode 323A deviates slightly in direction D304. Electrodes 314A and 314C have ends 4314A and 4314C opposite to ends 2314A and 2314C along the Y-axis, respectively. When no acceleration is applied, end 4314A of electrode 314A deviates slightly from end 4314C of electrode 314C in direction D303 along the Y-axis. Electrodes 318A and 318C have ends 4318A and 4318C opposite to ends 2318A and 2318C along the Y-axis, respectively. When no acceleration is applied, end 4318A of electrode 318A deviates slightly from end 4318C of electrode 318C in direction D304. Electrodes 317A and 317C have ends 4317A and 4317C opposite to ends 2317A and 2317C along the Y-axis, respectively. When no acceleration is applied, end 4317A of electrode 317A deviates slightly from end 4317C of electrode 317C in direction D303 along the Y-axis. Electrodes 321A and 321C have ends 4321A and 4321C opposite to ends 2321A and 2321C along the Y-axis, respectively. When no acceleration is applied, end 4321A of electrode 321A deviates slightly from end 4321C of electrode 321C in direction D304.

FIG. 24 is a sectional view of sensor element 301 on line 23-23 shown in FIGS. 19 and 20 when an acceleration along the Y-axis is applied. When acceleration 1003D directed in direction D303 along the Y-axis is applied, a force along the Y-axis due to acceleration 1003D deforms elastic portions 311 along the Y-axis, and do not deform along any of the X-axis and the Z-axis while the force is not converted into a rotational force. The force displaces ends 2314A and 2316A of electrodes 314A and 316A relatively with respect to ends 2314C and 2316C of electrodes 314C and 316C by distance W302 along the Y-axis. Similarly, the force displaces ends of electrodes 318A and 320A relatively with respect to the ends of electrodes 318C and 320C by distance W302 along the Y-axis. When weights 303A and 303C are displaced along the Y-axis due to acceleration 1003D, the capacitances of opposed electrode unit 314Y changes by an amount different from an amount of the change of the capacitances of opposed electrode unit 316Y. Similarly, when weights 303D and 303D are displaced along the Y-axis, the capacitances of opposed electrode unit 318Y changes by an amount different from an amount of the change of the capacitances of opposed electrode unit 320Y. Similarly, the force displaces ends 2317A and 2319A of electrodes 317A and 319A relatively with respect to ends 2317C and 2319C of electrodes 317C and 319C by distance W302 along the Y-axis. Similarly, the force displaces ends of electrodes 321A and 323A relatively with respect to the ends of electrodes 321C and 323C by distance W302 along the Y-axis. When weights 303A and 303C are displaced along the Y-axis due to acceleration 1003D, the capacitances of opposed electrode unit 317Y changes by an amount different from an amount of the change of the capacitances of opposed electrode unit 319Y. Similarly, when weights 303D and 303D are displaced along the Y-axis, the capacitances of opposed electrode unit 321Y changes by an amount different from an amount of the change of the capacitances of opposed electrode unit 323Y

Processor 361 detects acceleration 1003D along the Y-axis based on the amount of the change of the difference between a combined capacitance of opposed electrode units 314Y, 316Y, 317Y, and 319Y and a combined capacitance of opposed electrode units 318Y, 320Y, 321Y, and 323Y.

Sensor element 301 can detect acceleration 1003C along the X-axis since elastic portions 309 deform along the X-axis but not along any of the Y-axis and the Z-axis. Sensor element 301 can detect acceleration 1003D along the Y-axis since elastic portions 311 deform along the Y-axis but not along any of the X-axis and the Z-axis. Thus, sensor element 301 can detect acceleration 1003C along the X-axis and acceleration 1003D along the Y-axis at high sensitivity independently without mutual interference.

The amounts of the changes of the capacitances of opposed electrode units 314X and 316X due to acceleration 1003C are different from each other. The amounts of the changes of the capacitances of opposed electrode units 318X and 320X due to acceleration 1003C are different from each other. The amounts of the changes of the capacitances of opposed electrode units 317X and 319X due to acceleration 1003C are different from each other. The amounts of the changes of the capacitances of opposed electrode units 321X and 323X due to acceleration 1003C are different from each other. For example, when acceleration 1003C directed in a negative direction of the X-axis, as shown in FIG. 22, opposed electrode units 314X, 317X, 318X, and 321X decrease their capacitances, and opposed electrode units 316X, 319X, 319X, and 323X increase their capacitances. When an acceleration directed in the positive direction of the X-axis is applied, weights 303A to 303D are displaced in a direction opposite to the direction shown in FIG. 22. Therefore, opposed electrode units 314X, 317X, 318X, and 321X decrease their capacitances, and opposed electrode units 316X, 319X, 320X, and 323X decrease their capacitances. Processor 361 connected to sensor element 301 can determine, based on the capacitances of opposed electrode units 314X, 316X, 317X, 318X, 319X, 320X, 321X, and 323X, whether weights 303A to 303D have been displaced in the positive direction or the negative direction of the X-axis. Similarly, when acceleration 1003D directed in the negative direction of the Y-axis, as shown in FIG. 24, opposed electrode units 314Y, 317Y, 316Y, and 319Y decrease their capacitances, and opposed electrode units 318Y, 320Y, 321Y, and 323Y increase their capacitances. When acceleration directed in the positive direction of the Y-axis, weights 303A to 303D are displaced in a direction opposite to the direction shown in FIG. 24. Therefore, opposed electrode units 314Y, 317Y, 316Y, and 319Y increase their capacitances, and opposed electrode units 318Y, 320Y, 321Y, and 323Y decrease their capacitances. Processor 361 can distinguish, based on the capacitances of opposed electrode units 314Y, 316Y, 317Y, 318Y, 319Y, 320Y, 321Y, and 323Y, whether weights 303A to 303D are displaced in the positive direction or the negative direction of the Y-axis.

In inertial force sensor 1003, when weights 303A to 303D are displaced in the positive direction of the Z-axis, electrodes 314A, 316A, 318A, and 320A approach electrodes 314B, 314C, 316B, 316C, 318B, 318C, 320B, and 320C, whereas electrodes 317A, 319A, 321A, and 323A are displaced away from electrodes 317B, 317C, 319B, 319C, 321B, 321C, 323B, and 323C. When weights 303A to 303D are displaced in the negative direction of the Z-axis, electrodes 314A, 316A, 318A, and 320A are displaced away from electrodes 314B, 314B, 316B, 316B, 318B, 318C, 320B, and 320C, whereas electrodes 317A, 319A, 321A, and 323A approach electrodes 317B, 317C, 319B, 319C, 321B, 321C, 323B, and 323C. Thus, the displacement of weights 303A to 303D along the Z-axis does not change any of the sum of the distance between electrodes 314A and 314B and the distance between electrodes 317A and 317B, the sum of the distance between electrodes 314A and 314C and the distance between electrodes 317A and 317C, the sum of the distance between electrodes 316A and 316B and the distance between electrodes 319A and 319B, the sum of the distance between electrodes 316A and 316C and the distance between electrodes 319A and 319C, the sum of the distance between electrodes 318A and 318B and the distance between electrodes 321A and 321B, the sum of the distance between electrodes 318A and 318C and the distance between electrodes 321A and 321C, the sum of the distance between electrodes 320A and 320B and the distance between electrodes 323A and 323B, and the sum of the distance between electrodes 320A and 320C and the distance between electrodes 323A and 323C. As a result, the displacement of weights 303A to 303D along the Z-axis does not change any of a combined capacitance of opposed electrode units 314X and 317X, a combined capacitance of opposed electrode units 314Y and 317Y, a combined capacitance of opposed electrode units 316X and 319X, a combined capacitance of opposed electrode units 316Y and 319Y, a combined capacitance of opposed electrode units 318X and 312X, a combined capacitance of opposed electrode units 318Y and 321Y, a combined capacitance of opposed electrode units 320X and 323X, and a combined capacitance of opposed electrode units 320Y and 323Y Thus, inertial force sensor 1003 can detect accelerations 1003C and 1003D accurately based on these combined capacitances.

Single sensor element 301 which can detect both the acceleration and the angular velocity allows inertial force sensor 1003 to have a small footprint and a small size.

Elastic portions 309 which deform along the X-axis but not along any of the Y-axis and the Z-axis are placed at fixing portion 304 of sensor element 301 of inertial force sensor 1003. Alternatively, elastic portions 309 may be placed at arms 308 functioning as the linking unit of the inertial force sensor according to Embodiment 3. Elastic portions 311 which deform along the Y-axis but not along any of the X-axis and the Z-axis are placed at fixing portion 306 of sensor element 301. Alternatively, elastic portions 311 may be placed at fixing arm 307 functioning as the linking unit of the inertial force sensor according to Embodiment 3.

Driving electrode 322, detecting electrode 324, and sensing electrodes 326, 328 for detecting the angular velocity may have shapes and positions other than those described above.

Electrodes 314A, 316A, 317A, 318A, 319A, 320A, 321A, and 323A are largely displaced in the direction of the acceleration with respect to electrodes 314B, 314C, 316B, 316C, 317B, 317C, 318B, 318C, 319B, 319C, 320B, 320C, 321B, 321C, 323B, and 323C without causing the force due to the acceleration to be converted into rotational force. Thus, inertial force sensor 1003 according to Embodiment 3 detects the acceleration at high sensitivity.

### Exemplary Embodiment 4

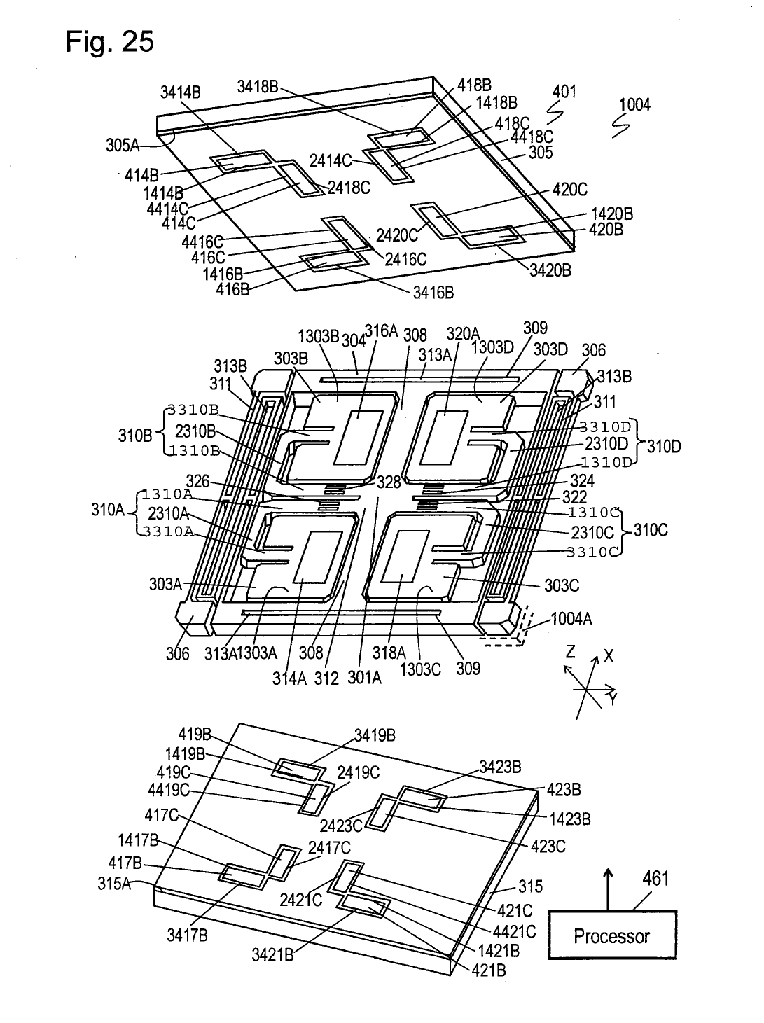

FIG. 25 is an exploded perspective view of sensor element 401 of inertial force sensor 1004 according to Exemplary Embodiment 4 of the present invention. In FIG. 25, components identical to those of sensor element 301 of inertial force sensor 1003 shown in FIG. 16A according to Embodiment 2 are denoted by the same reference numerals, and their description will be omitted. Sensor element 401 includes electrodes 414B, 414C, 416B, 416C, 417B, 417C, 418B, 418C, 419B, 419C, 420B, 420C, 421B, 421C, 423B, and 423C instead of electrodes 314B, 314C, 316B, 316C, 317B, 317C, 318B, 318C, 319B, 319C, 320B, 320C, 321B, 321C, 323B, and 323C of sensor element 301 according to Embodiment 3 shown in FIG. 16A. Sensor element 401 further includes grounding electrodes 430 and 440 provided on surfaces 305A and 315A of substrates 305 and 315, respectively. Grounding electrodes 430 and 440 are arranged to be grounded. Inertial force sensor 1004 includes opposed electrode units 414X, 414Y, 416X, 414Y, 417X, 417Y, 418X, 418Y, 419X, 419Y, 420X, 420Y, 421X, 421Y, 423X, and 423Y instead of opposed electrode units 314X, 314Y, 316X, 314Y, 317X, 317Y, 318X, 318Y, 319X, 319Y, 320X, 320Y, 321X, 321Y, 323X, and 323Y of inertial force sensor 1003 according to Embodiment 3.

Grounding electrode 430 is formed on an area of surface 305A of substrate 305 excluding areas having electrodes 414B, 414C, 416B, 416C, 418B, 418C, 420B, and 420C provided thereon. In other words, grounding electrode 430 is formed on an entire area of surface 305A positioned between electrodes 414B, 414C, 416B, 416C, 418B, 418C, 420B, and 420C and away from these electrodes and surrounding these electrodes individually. Grounding electrode 440 is formed on an area of surface 315A of substrate 315 excluding areas having electrodes 417B, 417C, 419B, 419C, 421B, 421C, 423B, and 423C provided thereon. In other words, grounding electrode 440 is formed on an entire area of surface 315A positioned between electrodes 417B, 417C, 419B, 419C, 421B, 421C, 423B, and 423C, away from these electrodes, and surrounding these electrodes individually.

Electrodes 314A and 414B facing each other and having a capacitance between the electrodes constitute opposed electrode unit 414X. Electrodes 316A and 416B facing each other and having a capacitance between the electrodes constitute opposed electrode unit 416X. Electrodes 317A and 417B facing each other and having a capacitance between the electrodes constitute opposed electrode unit 417X. Electrodes 318A and 418B facing each other and having a capacitance between the electrodes constitute opposed electrode unit 418X. Electrodes 319A and 419B facing each other and having a capacitance between the electrodes constitute opposed electrode unit 419X. Electrodes 320A and 420B facing each other and having a capacitance between the electrodes constitute opposed electrode unit 420X. Electrodes 321A and 421B facing each other and having a capacitance between the electrodes constitute opposed electrode unit 421X. Electrodes 323A and 423B facing each other and having a capacitance between the electrodes constitute opposed electrode unit 423X. Electrodes 314A and 414C facing each other and having a capacitance between the electrodes constitute opposed electrode unit 414Y. Electrodes 316A and 416C facing each other and having a capacitance between the electrodes constitute opposed electrode unit 416Y. Electrodes 317A and 417C facing each other and having a capacitance between the electrodes constitute opposed electrode unit 417Y. Electrodes 318A and 418C facing each other and having a capacitance between the electrodes constitute opposed electrode unit 418Y. Electrodes 319A and 419C facing each other and having a capacitance between the electrodes constitute opposed electrode unit 419Y. Electrodes 320A and 420C facing each other and having a capacitance between the electrodes constitute opposed electrode unit 420Y. Electrodes 321A and 421C facing each other and having a capacitance between the electrodes constitute opposed electrode unit 421Y. Electrodes 323A and 423C facing each other and having a capacitance between the electrodes constitute opposed electrode unit 423Y.

Inertial force sensor 1004 which includes driving electrode 322, detecting electrode 324, and sensing electrodes 326 and 328 can detect an angular velocity about the Z-axis similarly to inertial force sensor 1001 including driving electrode 122, detecting electrode 124, and sensing electrodes 126, 128 according to Embodiment 1 shown in FIG. 4.

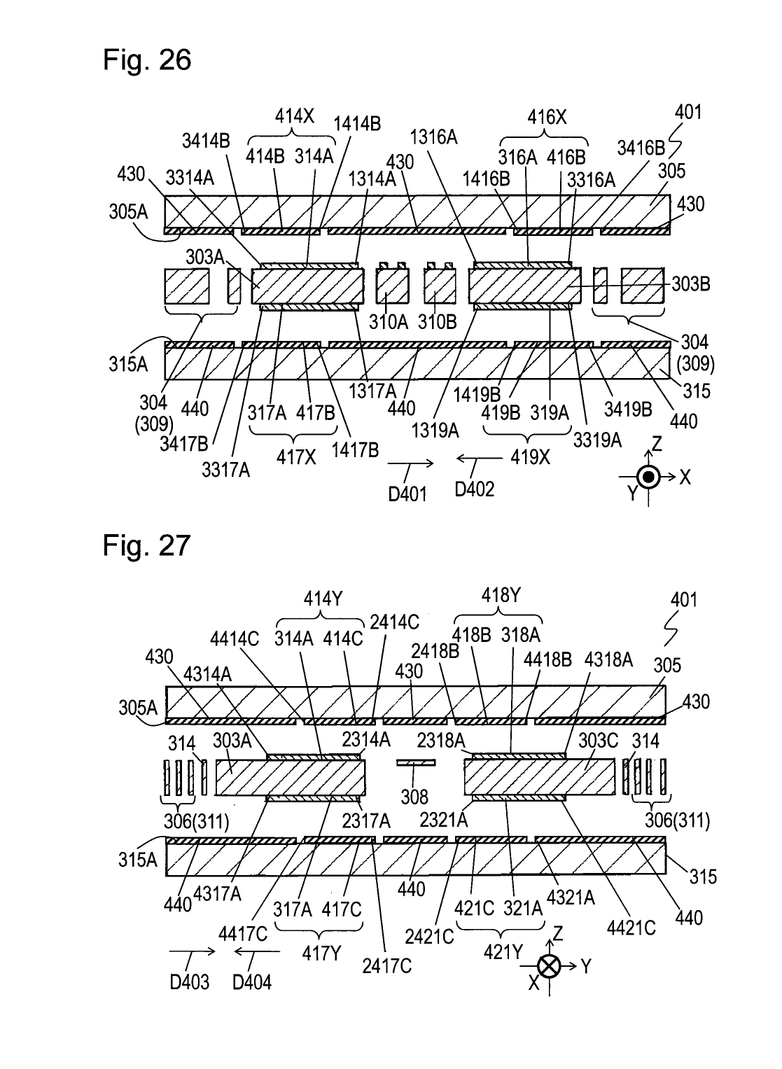

FIGS. 26 and 27 are sectional views of sensor element 401. Grounding electrode 430 surrounds electrodes 414B, 414C, 416B, 416C, 418B, 418C, 420B, and 420C individually and is positioned between these electrodes. Grounding electrode 440 surrounds electrodes 417B, 417C, 419B, 419C, 421B, 421C, 423B, and 423C individually and is positioned between these electrodes.

FIG. 26 shows sensor element 401 when no acceleration along the X-axis is applied. Ends 1314A and 1414B of electrodes 314A and 414B directed in the same direction along the X-axis face ends 1316A and 1416B of electrodes 316A and 416B directed in the same direction along the X-axis, respectively. When no acceleration is applied, end 1314A of electrode 314A deviates slightly from end 1414B of electrode 414B in direction D402 along the X-axis, and end 1316A of electrode 316A deviates slightly from end 1416B of electrode 416B in direction D401 opposite to direction D402. Similarly, ends 1318A and 1418B of electrodes 318A and 418B directed in the same direction along the X-axis face ends 1320A and 1420B of electrodes 320A and 420B directed in the same direction along the X-axis, respectively. When no acceleration is applied, end 1318A of electrode 318A deviates slightly from end 1418B of electrode 418B in direction D402 along the X-axis, and end 1320A of electrode 320A deviates slightly from end 1420B of electrode 420B in direction D401. Ends 1317A and 1417B of electrodes 317A and 417B directed in the same direction face ends 1319A and 1419B of electrodes 319A and 419B directed in the same direction, respectively. When no acceleration is applied, end 1317A of electrode 317A deviates slightly from end 1417B of electrode 417B in direction D402, and end 1319A of electrode 319A deviates slightly displaced in direction D401. Similarly, ends 1321A and 1321B of electrodes 321A and 321B directed in the same direction face ends 1323A and 1323B of electrodes 323A and 323B directed in the same direction, respectively. When no acceleration is applied, end 1321A of electrode 321A deviates slightly from end 1321B of electrode 321B in direction D402, and end 1323A of electrode 323A deviates slightly in direction D401. Electrodes 314A and 414B have ends 3314A and 3414B opposite to ends 1314A and 1414B along the X-axis, respectively. When no acceleration is applied, end 3314A of electrode 314A deviates slightly from end 3414B of electrode 414B in direction D402 along the X-axis. Electrodes 316A and 416B have ends 3316A and 3416B opposite to ends 1316A and 1416B along the X-axis, respectively. When no acceleration is applied, end 3316A of electrode 316A deviates slightly from end 3416B of electrode 416B in direction D401. Electrodes 317A and 417B have ends 3317A and 3417B opposite to ends 1317A and 1417B along the X-axis, respectively. When no acceleration is applied, end 3317A of electrode 317A deviates slightly from end 3417B of electrode 417B in direction D402 along the X-axis. Electrodes 319A and 419B have ends 3319A and 3419B opposite to ends 1319A and 1419B along the X-axis, respectively. When no acceleration is applied, end 3319A of electrode 319A deviates slightly from end 3419B of electrode 419B in direction D401.

When an acceleration along the X-axis is applied, inertial force sensor 1004 can detect the acceleration similarly to inertial force sensor 1003 according to Embodiment 3. In inertial force sensor 1004, the direction in which electrodes 414B, 416B, 417B, 418B, 419B, 420B, 421B, and 423B deviate from electrodes 314A, 316A, 317A, 318A, 319A, 320A, 321A, and 323A, respectively, is opposite to the direction in which electrodes 314B, 316B, 317B, 318B, 319B, 320B, 321B, and 323B deviate from electrodes 314A, 316A, 317A, 318A, 319A, 320A, 321A, and 323A, respectively, of inertial force sensor 1003 according to Embodiment 3 shown in FIG. 21. When the acceleration is applied, the capacitances of opposed electrode units 414X, 416X, 417X, 418X, 419X, 420X, 421X, and 423X change reversely to the change of the capacitances of opposed electrode units 314X, 316X, 317X, 318X, 319X, 320X, 321X, and 323X of inertial force sensor 1003 according to Embodiment 3. Besides this, inertial force sensor 1004 can detect the acceleration along the X-axis similarly to inertial force sensor 1003, thus providing the same effects.

FIG. 27 shows sensor element 401 when no acceleration along the Y-axis is applied. Ends 2314A and 2414C of electrodes 314A and 414C directed in the same direction along the Y-axis face ends 2316A and 2416C of electrodes 316A and 416C directed in the same direction along the Y-axis, respectively. When no acceleration is applied, end 2314A of electrode 314A deviates slightly from end 2414C of electrode 414C in direction D403 along the Y-axis, and end 2316A of electrode 316A deviates slightly from end 2416C of electrode 416C in direction D404 opposite to direction D403. Similarly, ends 2318A and 2418C of electrodes 318A and 418C directed in the same direction along the Y-axis respectively face ends 2320A and 2420C of electrodes 320A and 420C directed in the same direction along the Y-axis, respectively. When is no acceleration is applied, end 2318A of electrode 318A deviates slightly from end 2418C of electrode 418C in direction D403 along the Y-axis, and end 2320A of electrode 320A deviates slightly from end 2420C of electrode 420C in direction D404. Ends 2317A and 2417C of electrodes 317A and 417C directed in the same direction face ends 2319A and 2419C of electrodes 319A and 419C directed in the same direction, respectively. When no acceleration is applied, end 2317A of electrode 317A deviates slightly from end 2417C of electrode 417C in direction D403, and end 2319A of electrode 319A deviates slightly from end 2317C of electrode 317C in direction D404. Similarly, ends 2321A and 2321C of electrodes 321A and 321C directed in the same direction face ends 2323A and 2323C of electrodes 323A and 323C directed in the same direction, respectively. When no acceleration is applied, end 2321A of electrode 321A deviates slightly displaced from end 2321C of electrode 321C in direction D403, and end 2323A of electrode 323A deviates slightly in direction D404. Electrodes 314A and 414C have ends 4314A and 4414C opposite to ends 2314A and 2414C along the Y-axis, respectively. When no acceleration is applied, end 3314A of electrode 314A deviates slightly from end 4414C of electrode 414C in direction D403 along the Y-axis. Electrodes 316A and 416C have ends 3316A and 4416C opposite to ends 2316A and 2416C along the Y-axis, respectively. When no acceleration is applied, end 3316A of electrode 316A deviates slightly from end 4416C of electrode 416C in direction D404. Electrodes 317A and 417C have ends 3317A and 4417C opposite to ends 2317A and 2417C along the Y-axis, respectively. When no acceleration is applied, end 3317A of electrode 317A deviates slightly from end 4417C of electrode 417C in direction D403 along the Y-axis. Electrodes 319A and 419C have ends 3319A and 4419C opposite to ends 3319A and 4419C along the Y-axis, respectively. When no acceleration is applied, end 3319A of electrode 319A deviates slightly from end 4419C of electrode 419C in direction D404.

When an acceleration along the Y-axis is applied, inertial force sensor 1004 can detect the acceleration similarly to inertial force sensor 1003 according to Embodiment 3, providing the same effects.

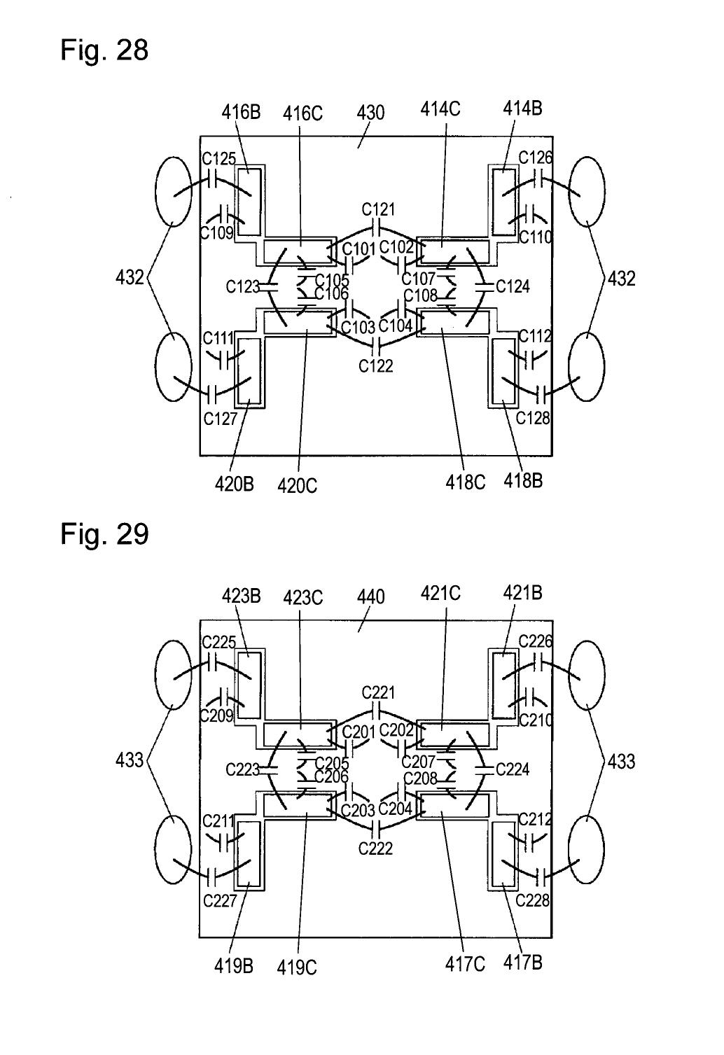

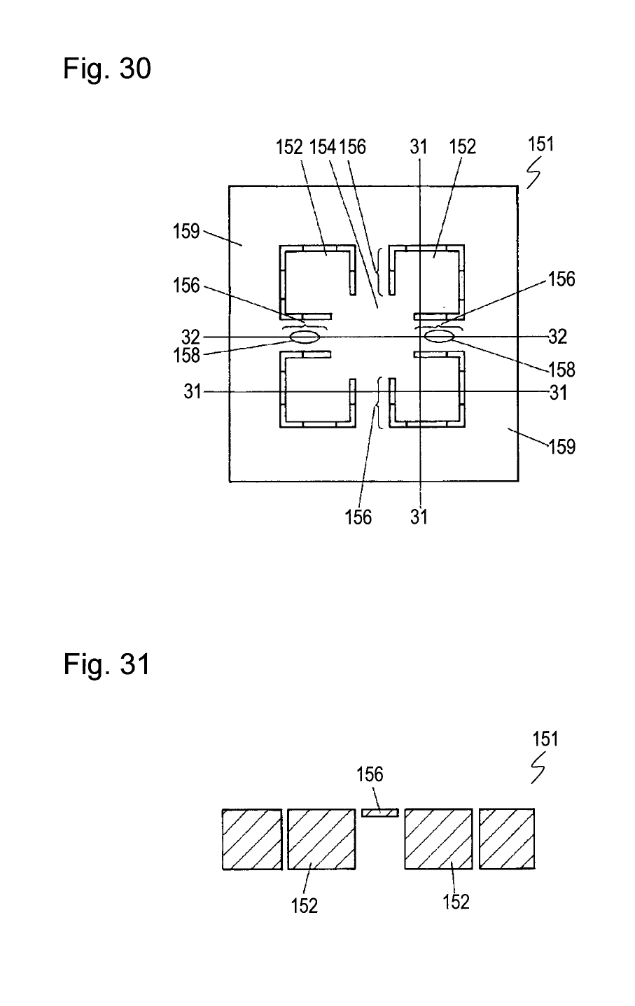

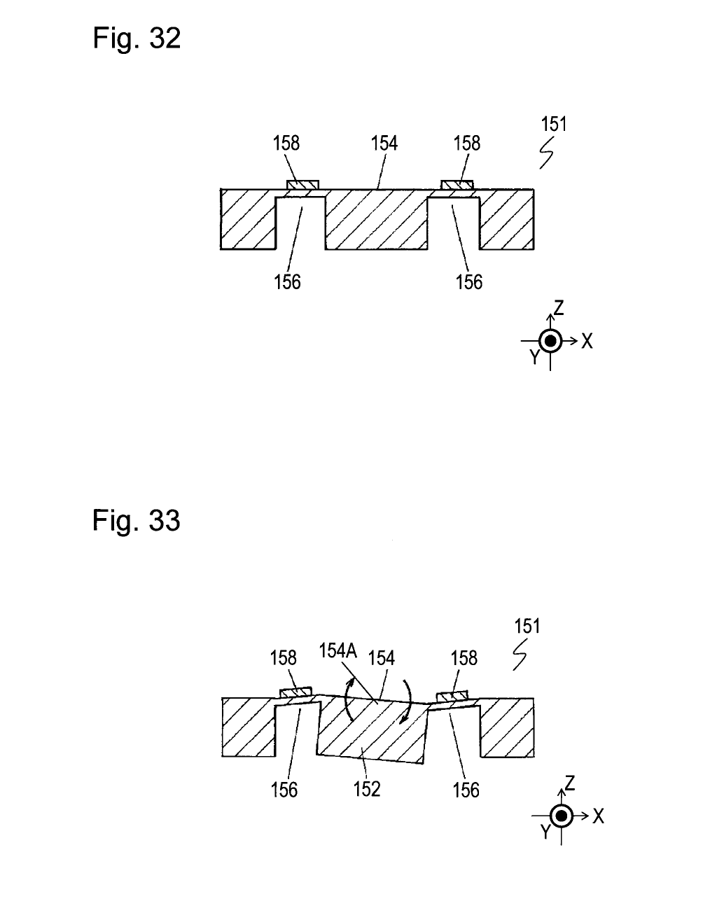

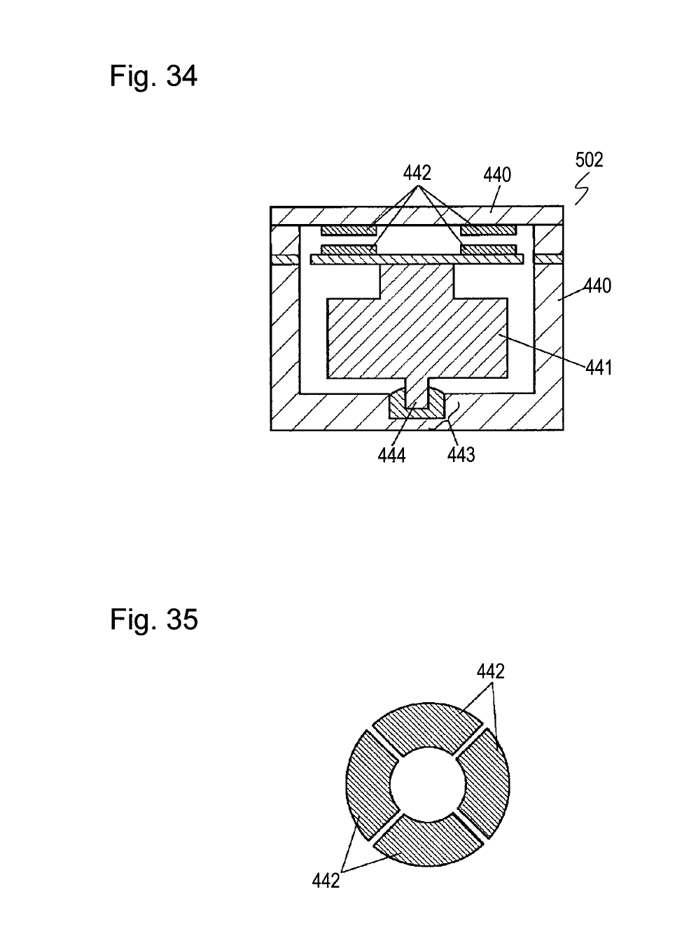

FIG. 28 is a plan view of the electrodes provided on substrate 305. Lands 432 which is arranged to have the signal lines connected thereto to mount inertial force sensor 1004 are provided around sensor element 401. Electrodes 414B, 414C, 416B, 416C, 418B, 418C, 420B, and 420C provided on surface 305A of substrate 305 are coupled to grounding electrode 430 via capacitances C101 to C112. Electrodes 414C, 416C, 418C, and 420C adjacent to each other are coupled to each other via capacitances C121 to C124. Electrodes 414B, 416B, 418B, and 420B are coupled to lands 432 via capacitances C125 to C128. Electrodes 414C, 416C, 418C, and 420C face electrodes 414A, 416A, 418A, and 420A which are displaced independently from each other. Lands 432 are connected to processor 461 which is outside sensor element 401. Capacitances C125 to C128 may cause noise on electrodes 414B, 416B, 418B, and 420B. However, capacitances C101 to C112 produced by grounding electrode 430 reduce capacitances C125 to C128, accordingly reducing the noise.

FIG. 29 is a plan view of electrodes on substrate 315. Lands 442 which is arranged to have the signal lines connected thereto to mount inertial force sensor 1004 are provided around sensor element 401. Electrodes 417B, 417C, 419B, 419C, 421B, 421C, 423B, and 423C provided on surface 305A of substrate 305 are coupled to grounding electrode 430 via capacitances C201 to C212. Electrodes 417C, 419C, 421C, and 423C adjacent to each other are coupled to each other via capacitances C221 to C224. Electrodes 417B, 419B, 421B, and 423B are coupled to lands 442 via capacitances C225 to C228. Electrodes 417C, 419C, 421C, and 423C face electrodes 417A, 419A, 421A, and 423A which are displaced independently from each other, respectively. Lands 442 are connected to processor 461 which is outside sensor element 401. Since inertial force sensor 1004 detects the acceleration based on the capacitances between the electrodes, capacitances C225 to C228 may cause a noise on electrodes 417B, 419B, 421B, and 423B. However, capacitances C201 to. C212 produced by grounding electrode 430 can reduce capacitances C225 to 0228, thereby reducing the noise. Thus, inertial force sensor 1004 according to Embodiment 4 does not generate errors due to the noise, and detect the acceleration at high sensitivity accurately.

### INDUSTRIAL APPLICABILITY

This inertial force sensor can detect an acceleration at high sensitivity and is suitable for various electronic devices.

1. An inertial force sensor arranged to detecting an acceleration of an object, said inertial force sensor comprising:
a weight having a first surface and a second surface which are opposite to each other along a first axis;
a first fixing portion linked to the weight;
a second fixing portion linked to the weight via the first fixing portion, the second fixing portion being arranged to be fixed to the object;
a first substrate having a surface facing the first surface of the weight;
a first opposed electrode unit including
a first electrode on the first surface of the weight, and
a second electrode on the surface of the first substrate and facing the first electrode, wherein the first opposed electrode unit has a capacitance between the first electrode and the second electrode to detect the acceleration based on the capacitance between the first electrode and the second electrode;
a first elastic portion elastically deforming so as to displace the weight along a second axis perpendicular to the first axis but not along any of the first axis and a third axis perpendicular to the first axis and the second axis; and
a second elastic portion elastically deforming so as to displace the first fixing portion along the third axis but not along any of the first axis and the second axis.

2. The inertial force sensor of claim 1, wherein
the second elastic portion elastically deforms so as to displace the first fixing portion along the third axis but not along any of the first axis and the second axis,
the first elastic portion is implemented by a slit which is provided in the first fixing portion and which extends along the third axis, and
the second elastic portion is implemented by a slit which is provided in the second fixing portion and which extends along the second axis.

3. The inertial force sensor of claim 1, further comprising a second opposed electrode unit including
a third electrode provided on the first surface of the weight, the third electrode and the first electrode being arranged along the second axis, and
a fourth electrode provided on the surface of the first substrate and facing the third electrode, wherein the second opposed electrode unit has a capacitance between the third electrode and the fourth electrode to detect the acceleration based on the capacitance between the third electrode and the fourth electrode,
wherein, when the weight is displaced along the second axis, the capacitance of the first opposed electrode unit changes by an amount different from an amount of a change of the capacitance of the second opposed electrode unit.

4. The inertial force sensor of claim 3, wherein the weight includes
a first weight having the first electrode provided thereon, and
a second weight having the third electrode provided thereon.

5. The inertial force sensor of claim 3, further comprising a grounding electrode formed on the surface of the first substrate, the grounding electrode surrounding the second electrode and the fourth electrode individually and being positioned between the second electrode and the fourth electrode.

6. The inertial force sensor of claim 3, wherein
a first end of the first electrode and a second end of the second electrode face a third end of the third electrode and a fourth end of the fourth electrode along the second axis, respectively,
the first end of the first electrode deviates from the second end of the second electrode in a predetermined direction along the second axis, and
the third end of the third electrode deviates from the fourth end of the fourth electrode in a direction opposite to the predetermined direction.

7. The inertial force sensor of claim 1, further comprising a second opposed electrode unit including
a third electrode provided on the first surface of the weight, the third electrode and the first electrode being arranged along the third axis, and
a fourth electrode provided on the surface of the first substrate and facing the third electrode, wherein the second opposed electrode unit has a capacitance between the third electrode and the fourth electrode to detect the acceleration based on the capacitance between the third electrode and the fourth electrode,
wherein, when the weight is displaced along the third axis, the capacitance of the first opposed electrode unit changes by an amount different from an amount of a change of the capacitance of the second opposed electrode unit.

8. The inertial force sensor of claim 7, wherein the weight includes
a first weight having the first electrode provided thereon, and
a second weight having the third electrode provided thereon.

9. The inertial force sensor of claim 7, further comprising a grounding electrode formed on the surface of the first substrate, the grounding electrode surrounding the second electrode and the fourth electrode individually and being positioned between the second electrode and the fourth electrode.

10. The inertial force sensor of claim 7, wherein
a first end of the first electrode and a second end of the second electrode face a third end of the third electrode and a fourth end of the fourth electrode along the third axis, respectively,
the first end of the first electrode deviates from the second end of the second electrode in a predetermined direction along the third axis, and
the third end of the third electrode deviates from the fourth end of the fourth electrode in a direction opposite to the predetermined direction.

11. The inertial force sensor of claim 1, wherein
the first fixing portion has a frame shape, and
the weight is arranged inside the frame shape of the first fixing portion.

12. The inertial force sensor of claim 1, further comprising an arm connected to the weight and positioned between the weight and the first fixing portion so as to vibrate the weight, wherein
the object is rotatable, and
said inertial force sensor detects an angular velocity of the object based on a Coriolis force generated by vibration of the weight and rotation of the object.

13. The inertial force sensor of claim 12, wherein
the arm has substantially a U-shape, and has strain produced by the Coriolis force, and
said inertial force sensor detects the angular velocity based on the strain.

14. The inertial force sensor of claim 1, further comprising:
a second substrate having a surface facing the second surface of the weight; and
a second opposed electrode unit including
a third electrode provided on the second surface of the weight, and
a fourth electrode provided on the surface of the second substrate and facing the third electrode, wherein the second opposed electrode unit has a capacitance between the third electrode and the fourth electrode to detect the acceleration based on the capacitance between the third electrode and the fourth electrode.

15. The inertial force sensor of claim 14, further comprising:
a third opposed electrode unit including
a fifth electrode provided on the first surface of the weight, the fifth electrode and the first electrode being arranged along the third axis, and
a sixth electrode provided on the surface of the first substrate and facing the fifth electrode, wherein the third opposed electrode unit has a capacitance between the fifth electrode and the sixth electrode to detect the acceleration based on the capacitance between the fifth electrode and the sixth electrode; and
a fourth opposed electrode unit including
a seventh electrode provided on the second surface of the weight, the seventh electrode and the third electrode being arranged along the third axis, and
an eighth electrode provided on the surface of the second substrate and facing the seventh electrode, wherein the fourth opposed electrode unit has a capacitance between the seventh electrode and the eighth electrode to detect the acceleration based on the capacitance between the seventh electrode and the eighth electrode, wherein
when the weight is displaced along the third axis, the capacitance of the first opposed electrode unit changes by an amount different from an amount of a change of the capacitance of the third opposed electrode unit, and
when the weight is displaced along the third axis, the capacitance of the second opposed electrode unit changes by an amount different from an amount of a change of the capacitance of the fourth opposed electrode unit.

16. The inertial force sensor of claim 15, wherein
a first end of the first electrode and a second end of the second electrode face a third end of the third electrode and a fourth end of the fourth electrode along the third axis, respectively,
the first end of the first electrode deviates from the second end of the second electrode in a predetermined direction along the third axis,
the third end of the third electrode deviates from the fourth end of the fourth electrode in a direction opposite to the predetermined direction,
a fifth end of the fifth electrode and a sixth end of the sixth electrode face a seventh end of the seventh electrode and an eighth end of the eighth electrode along the third axis, respectively
the fifth end of the fifth electrode deviates from the sixth end of the sixth electrode in the predetermined direction, and
the seventh end of the seventh electrode deviates from the ninth end of the ninth electrode in the direction opposite to the predetermined direction.

17. The inertial force sensor of claim 15, further comprising:
a first grounding electrode provided on the surface of the first substrate, the first grounding electrode surrounding the second electrode and the sixth electrode individually and being positioned between the second electrode and the sixth electrode; and
a second grounding electrode provided on the surface of the second substrate, the second grounding electrode surrounding the fourth electrode and the eighth electrode individually and being positioned between the fourth electrode and the eighth electrode.

18. The inertial force sensor of claim 15, further comprising:
a fifth opposed electrode unit including
a ninth electrode provided on the first surface of the weight, the ninth electrode and the first electrode being arranged along the second axis, and
a tenth electrode provided on the surface of the first substrate and facing the ninth electrode, wherein the fifth opposed electrode unit has a capacitance between the ninth electrode and the tenth electrode to detect the acceleration based on the capacitance between the ninth electrode and the tenth electrode; and
a sixth opposed electrode unit including
an eleventh electrode provided on the second surface of the weight, the eleventh electrode and the third electrode being arranged along the second axis; and
a twelfth electrode provided on the surface of the second substrate and facing the eleventh electrode, the sixth opposed electrode unit has a capacitance between the eleventh electrode and the twelfth electrode to detect the acceleration based on the capacitance between the eleventh electrode and the twelfth electrode, wherein
when the weight is displaced along the second axis, the capacitance of the first opposed electrode unit changes by an amount different from an amount of a change of the capacitance of and the fifth opposed electrode unit, and
when the weight is displaced along the second axis, the capacitance of the second opposed electrode unit changes by an amount different from an amount of a change of the capacitance of the sixth opposed electrode unit.

19. The inertial force sensor of claim 18, wherein
a first end of the first electrode and a second end of the second electrode face a ninth end of the ninth electrode and a tenth end of the tenth electrode along the second axis, respectively,
the first end of the first electrode deviates from the second end of the second electrode in a predetermined direction along the second axis,
the ninth end of the ninth electrode deviates from the tenth end of the tenth electrode in a direction opposite to the predetermined direction,
a third end of the third electrode and a fourth end of the fourth electrode face a an eleventh end of the eleventh electrode and a twelfth end of the twelfth electrode along the second axis, respectively,
the third end of the third electrode deviates from the fourth end of the fourth electrode in the predetermined direction, and
the eleventh end of the eleventh electrode deviates from the twelfth end of the twelfth electrode in the direction opposite to the predetermined direction.

20. The inertial force sensor of claim 18, wherein said inertial force sensor detects the acceleration based on a combined capacitance of the first opposed electrode unit and the second opposed electrode unit, and a combined capacitance of the fifth opposed electrode unit and the sixth opposed electrode unit.

21. The inertial force sensor of claim 18, wherein the weight includes
a first weight having the first electrode and the third electrode provided thereon,
a second weight having the fifth electrode and the seventh electrode provided thereon, and
a third weight having the ninth electrode and the eleventh electrode provided thereon.

22. The inertial force sensor of claim 18, further comprising:
a first grounding electrode provided on the surface of the first substrate, the first grounding electrode surrounding the second electrode, the sixth electrode, and the tenth electrode individually and being positioned between the second electrode, the sixth electrode, and the tenth electrode, and
a second grounding electrode provided on the surface of the second substrate, second grounding electrode surrounding the fourth electrode, the eighth electrode, and the twelfth electrode individually and being positioned between the fourth electrode, the eighth electrode, and the twelfth electrode.
